(19) United States
(12) Patent Application Publication
(10) Pub. No.: US 2025/0071295 A1
(43) Pub. Date: Feb. 27, 2025

(54) GRADUAL DECODING REFRESH

(71) Applicant: Nokia Technologies Oy, Espoo (FI)

(72) Inventors: Limin WANG, San Diego, CA (US); Seungwook HONG, San Diego, CA (US); Krit PANUSOPONE, San Diego, CA (US); Miska Matias HANNUKSELA, Tampere (FI); Jani LAINEMA, Tampere (FI)

(21) Appl. No.: 18/724,393

(22) PCT Filed: Nov. 17, 2022
(86) PCT No.: PCT/EP2022/082244

§ 371 Date: Jun. 26, 2024

Related U.S. Application Data
(60) Provisional application No. 63/296,590, filed on Jan. 5, 2022.

(51) Int. Cl. H04N 19/167; H04N 19/105; H04N 19/172; H04N 19/82

(52) U.S. Cl. CPC H04N 19/167; H04N 19/105; H04N 19/172; H04N 19/82

(57) ABSTRACT

There are disclosed various methods, apparatuses and computer program products for video encoding. In some embodiments the method comprises obtaining a coding unit of a coding tree unit of a picture comprising a refreshed region and a non-refreshed region and a virtual boundary between the refreshed region and the non-refreshed region; examining whether the coding unit belongs to the refreshed region or to the non-refreshed region; treating the virtual boundary as a picture boundary when determining that the coding unit belongs to the refreshed region; or treating the virtual boundary as no boundary when determining that the coding unit belongs to the non-refreshed region.

### TECHNICAL FIELD

There is provided an apparatus, a method and a computer program for gradual decoding refresh of video information.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

In the current versatile video coding (VVC) design, a coded video sequence consists of intra coded pictures (e.g. I picture) and inter coded pictures (e.g. P and B pictures). Intra coded pictures usually use many more bits than inter coded pictures. Transmission time of such big intra coded pictures increases the encoder to decoder delay. For (ultra) low delay applications, it is desirable that all the coded pictures have similar number of bits so that the encoder to decoder delay can be reduced to around 1 picture interval. Hence, intra coded picture seems not fit for (ultra) low delay applications. However, on the other hand, an intra coded picture may be needed at a random access point.

Gradual Decoding Refresh (GDR) (Gradual Random Access (GRA) or Progressive Intra Refresh (PIR)) approaches alleviates the delay issue with intra coded pictures. Instead of coding an intra picture at a random access point, GDR progressively refreshes pictures by spreading intra coded areas over several pictures.

One of the requirements for VVC GDR is “exact match” at recovery points. With exact match, the reconstructed pictures at recovery points of encoder and decoder should be identical (or matched). To achieve exact match, coding units (CUs) in clean areas should not use any coding information (e.g. reconstructed pixels, code mode, motion vector (MV), reference picture index (refIdx), reference picture list (refList), etc.) from dirty areas, because the coding information in dirty areas may not be decoded correctly at decoder. The incorrectly decoded information from dirty areas may contaminate the clean areas, which will result in mismatch of encoder and decoder at recovery points (or leaks). Many coding tools in VVC, however, may involve in using the coding information from dirty areas for CUs in clean areas.

Under the VVC design, a current CU is heavily predictive coded both spatially and temporally. Many coding tools in VVC use the coding information from the past coded neighboring CUs to predictively code a current CU. It is very likely that for a current CU in clean area, the past coded neighboring CUs may be associated with the dirty areas, which will result in leaks, and hence exact match at the recovery point becomes impossible.

### SUMMARY

Some embodiments provide a method for encoding and decoding video information. In some embodiments a new gradual decoding reference architecture is provided, which aims to allow output of GDR/recovering pictures even if decoding starts at a GDR picture. The architecture may also remove the constraints on coding tools that have to be imposed under the current VVC standard, and also may provide flexibility in future tool development. In some embodiments, in-loop filters may be enabled at virtual boundary.

Various aspects of examples of the invention are provided in the detailed description.

An advantage of some embodiments is to allow output of GDR/recovering pictures even if decoding starts at a GDR picture, possibly remove the constraints on coding tools that have to be imposed under the current VVC standard, may provide flexibility in future tool development, and may enable in-loop filters at virtual boundary.

According to a first aspect, there is provided an apparatus comprising means for:
obtaining a coding unit of a coding tree unit of a picture comprising a refreshed region and a non-refreshed region and a virtual boundary between the refreshed region and the non-refreshed region;
examining whether the coding unit belongs to the refreshed region or to the non-refreshed region;
treating the virtual boundary as a picture boundary when determining that the coding unit belongs to the refreshed region; or
treating the virtual boundary as no boundary when determining that the coding unit belongs to the non-refreshed region.

A method according to a second aspect comprises:
obtaining a coding unit of a coding tree unit of a picture comprising a refreshed region and a non-refreshed region and a virtual boundary between the refreshed region and the non-refreshed region;
examining whether the coding unit belongs to the refreshed region or to the non-refreshed region;
treating the virtual boundary as a picture boundary when determining that the coding unit belongs to the refreshed region; or
treating the virtual boundary as no boundary when determining that the coding unit belongs to the non-refreshed region

An apparatus according to a third aspect comprises at least one processor and at least one memory, said at least one memory stored with computer program code thereon, the at least one memory and the computer program code configured to, with the at least one processor, cause the apparatus at least to perform:
obtain a coding unit of a coding tree unit of a picture comprising a refreshed region and a non-refreshed region and a virtual boundary between the refreshed region and the non-refreshed region;
examine whether the coding unit belongs to the refreshed region or to the non-refreshed region;
treat the virtual boundary as a picture boundary when determining that the coding unit belongs to the refreshed region; or
treat the virtual boundary as no boundary when determining that the coding unit belongs to the non-refreshed region.

According to a fourth aspect there is provided a computer readable storage medium stored with code thereon for use by an apparatus, which when executed by a processor, causes the apparatus to perform:
obtain a coding unit of a coding tree unit of a picture comprising a refreshed region and a non-refreshed region and a virtual boundary between the refreshed region and the non-refreshed region;
examine whether the coding unit belongs to the refreshed region or to the non-refreshed region;
treat the virtual boundary as a picture boundary when determining that the coding unit belongs to the refreshed region; or
treat the virtual boundary as no boundary when determining that the coding unit belongs to the non-refreshed region.

According to a fifth aspect, there is provided an encoder comprising means for:
obtaining a coding unit of a coding tree unit of a picture comprising a refreshed region and a non-refreshed region and a virtual boundary between the refreshed region and the non-refreshed region;
examining whether the coding unit belongs to the refreshed region or to the non-refreshed region;
treating the virtual boundary as a picture boundary when determining that the coding unit belongs to the refreshed region; or
treating the virtual boundary as no boundary when determining that the coding unit belongs to the non-refreshed region.

According to a sixth aspect, there is provided a decoder comprising means for:
obtaining a coding unit of a coding tree unit of a picture comprising a refreshed region and a non-refreshed region and a virtual boundary between the refreshed region and the non-refreshed region;
examining whether the coding unit belongs to the refreshed region or to the non-refreshed region;
treating the virtual boundary as a picture boundary when determining that the coding unit belongs to the refreshed region; or
treating the virtual boundary as no boundary when determining that the coding unit belongs to the non-refreshed region.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example of (vertical) GDR, where a GDR period starts with a GDR picture of POC(n) and ends with picture of POC(n+N−1), and a GDR/recovering picture consists of a clean area and a dirty area separated by a virtual boundary;

FIG. 2 illustrates an example of an output of GDR under VVC specification and an output of GDR according to an example embodiment;

FIG. 3 shows two mixed-area CTUs;

FIG. 4 shows an example related to an angular intra mode, where an intra CU in a clean area and some of its reference samples for angular intra modes are in a dirty area;

FIGS. 5a to 5d show an example, where CUs in intra block prediction mode may refer to a past-coded area of a current picture;

FIG. 6 shows an example, where a current CU is on a clean side of a virtual boundary;

FIG. 7 shows a reference picture for CUs in the clean area of a current picture, where reconstructed pixels in a dirty area are padded from reconstructed pixels in a clean area and coding information in the dirty area are set as “not available”;

FIG. 8 shows an example of a mixed-area CTU;

FIG. 9 shows an example of a deblocking filter at a virtual boundary;

FIGS. 10a to 10c illustrate sample adaptive offset filtering, in accordance with an approach;

FIG. 11 shows an example of an adaptive loop filter at a virtual boundary;

FIG. 12 illustrates an example of a situation in which a virtual boundary passes through a CTU of 128×128, where a current CU of 32×32 is in a clean area;

FIG. 13 illustrates an example of an apparatus;

FIG. 14a shows an encoding process according to an embodiment;

FIG. 14b shows a decoding process according to an embodiment;

FIG. 15 shows a method according to an embodiment as a flow diagram; and

FIG. 16 shows a schematic diagram of an example multimedia communication system within which various embodiments may be implemented.

### DETAILED DESCRIPTION OF SOME EXAMPLE EMBODIMENTS

The following description and drawings are illustrative and are not to be construed as unnecessarily limiting. The specific details are provided for a thorough understanding of the disclosure. However, in certain instances, well-known or conventional details are not described in order to avoid obscuring the description. References to one or an embodiment in the present disclosure can be, but not necessarily are, reference to the same embodiment and such references mean at least one of the embodiments.

Reference in this specification to “one embodiment” or “an embodiment” means that a particular feature, structure, or characteristic described in connection with the embodiment in included in at least one embodiment of the disclosure.

In the following, several embodiments will be described in the context of one video coding arrangement. It is to be noted, however, that the present embodiments are not necessarily limited to this particular arrangement.

The Advanced Video Coding standard (which may be abbreviated AVC or H.264/AVC) was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organization for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, each integrating new extensions or features to the specification. These extensions include Scalable Video Coding (SVC) and Multiview Video Coding (MVC).

The High Efficiency Video Coding standard (which may be abbreviated HEVC or H.265/HEVC) was developed by the Joint Collaborative Team—Video Coding (JCT-VC) of VCEG and MPEG. The standard is published by both parent standardization organizations, and it is referred to as ITU-T Recommendation H.265 and ISO/IEC International Standard 23008-2, also known as MPEG-H Part 2 High Efficiency Video Coding (HEVC). Extensions to H.265/HEVC include scalable, multiview, three-dimensional, and fidelity range extensions, which may be referred to as SHVC, MV-HEVC, 3D-HEVC, and REXT, respectively. The references in this description to H.265/HEVC, SHVC, MV-HEVC, 3D-HEVC and REXT that have been made for the purpose of understanding definitions, structures or concepts of these standard specifications are to be understood to be references to the latest versions of these standards that were available before the date of this application, unless otherwise indicated.

Versatile Video Coding (which may be abbreviated VVC, H.266, or H.266/VVC) is a video compression standard developed as the successor to HEVC. VVC is specified in ITU-T Recommendation H.266 and equivalently in ISO/IEC 23090-3, which is also referred to as MPEG-I Part 3.

A specification of the AV1 bitstream format and decoding process were developed by the Alliance of Open Media (AOM). The AV1 specification was published in 2018. AOM is reportedly working on the AV2 specification.

Some key definitions, bitstream and coding structures, and concepts of H.264/AVC, HEVC, VVC, and/or AV1 and some of their extensions are described in this section as an example of a video encoder, decoder, encoding method, decoding method, and a bitstream structure, wherein the embodiments may be implemented. The aspects of various embodiments are not limited to H.264/AVC, HEVC, VVC, and/or AV1 or their extensions, but rather the description is given for one possible basis on top of which the present embodiments may be partly or fully realized.

Video codec may comprise an encoder that transforms the input video into a compressed representation suited for storage/transmission and a decoder that can uncompress the compressed video representation back into a viewable form. The compressed representation may be referred to as a bitstream or a video bitstream. A video encoder and/or a video decoder may also be separate from each other, i.e. need not form a codec. The encoder may discard some information in the original video sequence in order to represent the video in a more compact form (that is, at lower bitrate).

Hybrid video codecs, for example ITU-T H.264, may encode the video information in two phases. At first, pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Then, the prediction error, i.e. the difference between the predicted block of pixels and the original block of pixels, is coded. This may be done by transforming the difference in pixel values using a specified transform (e.g. Discreet Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

In temporal prediction, the sources of prediction are previously decoded pictures (a.k.a. reference pictures). In intra block copy (IBC; a.k.a. intra-block-copy prediction or current picture referencing), prediction is applied similarly to temporal prediction, but the reference picture is the current picture and only previously decoded samples can be referred in the prediction process. Inter-layer or inter-view prediction may be applied similarly to temporal prediction, but the reference picture is a decoded picture from another scalable layer or from another view, respectively. In some cases, inter prediction may refer to temporal prediction only, while in other cases inter prediction may refer collectively to temporal prediction and any of intra block copy, inter-layer prediction, and inter-view prediction provided that they are performed with the same or similar process than temporal prediction. Inter prediction or temporal prediction may sometimes be referred to as motion compensation or motion-compensated prediction.

Intra prediction utilizes the fact that adjacent pixels within the same picture are likely to be correlated. Intra prediction can be performed in spatial or transform domain, i.e., either sample values or transform coefficients can be predicted. Intra prediction may be exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

Entropy coding/decoding may be performed in many ways. For example, context-based coding/decoding may be applied, where both the encoder and the decoder modify the context state of a coding parameter based on previously coded/decoded coding parameters. Context-based coding may, for example, be context adaptive binary arithmetic coding (CABAC) or context-based variable length coding (CAVLC) or any similar entropy coding. Entropy coding/decoding may alternatively or additionally be performed using a variable length coding scheme, such as Huffman coding/decoding or Exp-Golomb coding/decoding. Decoding of coding parameters from an entropy-coded bitstream or codewords may be referred to as parsing.

Video coding standards may specify the bitstream syntax and semantics as well as the decoding process for error-free bitstreams, whereas the encoding process might not be specified, but encoders may just be required to generate conforming bitstreams. Bitstream and decoder conformance can be verified with the Hypothetical Reference Decoder (HRD). The standards may contain coding tools that help in coping with transmission errors and losses, but the use of the tools in encoding may be optional and decoding process for erroneous bitstreams might not have been specified.

A syntax element may be defined as an element of data represented in the bitstream. A syntax structure may be defined as zero or more syntax elements present together in the bitstream in a specified order.

An elementary unit for the input to an encoder and the output of a decoder, respectively, in most cases is a picture. A picture given as an input to an encoder may also be referred to as a source picture, and a picture decoded by a decoder may be referred to as a decoded picture or a reconstructed picture.

The source and decoded pictures are each comprised of one or more sample arrays, such as one of the following sets of sample arrays:
Luma (Y) only (monochrome).
Luma and two chroma (YCbCr or YCgCo).
Green, Blue and Red (GBR, also known as RGB).
Arrays representing other unspecified monochrome or ti-stimulus color samplings (for example, YZX, also known as XYZ).

In the following, these arrays may be referred to as luma (or L or Y) and chroma, where the two chroma arrays may be referred to as Cb and Cr; regardless of the actual color representation method in use. The actual color representation method in use can be indicated e.g. in a coded bitstream e.g. using the Video Usability Information (VUI) syntax of HEVC or alike. A component may be defined as an array or single sample from one of the three sample arrays (luma and two chroma) or the array or a single sample of the array that compose a picture in monochrome format.

A picture may be defined to be either a frame or a field. A frame comprises a matrix of luma samples and possibly the corresponding chroma samples. A field is a set of alternate sample rows of a frame and may be used as encoder input, when the source signal is interlaced. Chroma sample arrays may be absent (and hence monochrome sampling may be in use) or chroma sample arrays may be subsampled when compared to luma sample arrays.

Some chroma formats may be summarized as follows:
In monochrome sampling there is only one sample array, which may be nominally considered the luma array.
In 4:2:0 sampling, each of the two chroma arrays has half the height and half the width of the luma array.
In 4:2:2 sampling, each of the two chroma arrays has the same height and half the width of the luma array.
In 4:4:4 sampling when no separate color planes are in use, each of the two chroma arrays has the same height and width as the luma array.

Coding formats or standards may allow to code sample arrays as separate color planes into the bitstream and respectively decode separately coded color planes from the bitstream. When separate color planes are in use, each one of them is separately processed (by the encoder and/or the decoder) as a picture with monochrome sampling.

When chroma subsampling is in use (e.g. 4:2:0 or 4:2:2 chroma sampling), the location of chroma samples with respect to luma samples may be determined in the encoder side (e.g. as pre-processing step or as part of encoding). The chroma sample positions with respect to luma sample positions may be pre-defined for example in a coding standard, such as H.264/AVC or HEVC, or may be indicated in the bitstream for example as part of VUI of H.264/AVC or HEVC.

Generally, the source video sequence(s) provided as input for encoding may either represent interlaced source content or progressive source content. Fields of opposite parity have been captured at different times for interlaced source content. Progressive source content contains captured frames. An encoder may encode fields of interlaced source content in two ways: a pair of interlaced fields may be coded into a coded frame or a field may be coded as a coded field. Likewise, an encoder may encode frames of progressive source content in two ways: a frame of progressive source content may be coded into a coded frame or a pair of coded fields. A field pair or a complementary field pair may be defined as two fields next to each other in decoding and/or output order, having opposite parity (i.e. one being a top field and another being a bottom field) and neither belonging to any other complementary field pair. Some video coding standards or schemes allow mixing of coded frames and coded fields in the same coded video sequence. Moreover, predicting a coded field from a field in a coded frame and/or predicting a coded frame for a complementary field pair (coded as fields) may be enabled in encoding and/or decoding.

Partitioning may be defined as a division of a set into subsets such that each element of the set is in exactly one of the subsets.

In H.264/AVC, a macroblock is a 16×16 block of luma samples and the corresponding blocks of chroma samples. For example, in the 4:2:0 sampling pattern, a macroblock contains one 8×8 block of chroma samples per each chroma component. In H.264/AVC, a picture is partitioned to one or more slice groups, and a slice group contains one or more slices. In H.264/AVC, a slice consists of an integer number of macroblocks ordered consecutively in the raster scan within a particular slice group.

When describing the operation of HEVC encoding and/or decoding, the following terms may be used. A coding block may be defined as an N×N block of samples for some value of N such that the division of a coding tree block into coding blocks is a partitioning. A coding tree block (CTB) may be defined as an N×N block of samples for some value of N such that the division of a component into coding tree blocks is a partitioning. A coding tree unit (CTU) may be defined as a coding tree block of luma samples, two corresponding coding tree blocks of chroma samples of a picture that has three sample arrays, or a coding tree block of samples of a monochrome picture or a picture that is coded using three separate color planes and syntax structures used to code the samples. A coding unit (CU) may be defined as a coding block of luma samples, two corresponding coding blocks of chroma samples of a picture that has three sample arrays, or a coding block of samples of a monochrome picture or a picture that is coded using three separate color planes and syntax structures used to code the samples.

In some video codecs, such as High Efficiency Video Coding (HEVC) codec, video pictures may be divided into coding units (CU) covering the area of the picture. A CU consists of one or more prediction units (PU) defining the prediction process for the samples within the CU and one or more transform units (TU) defining the prediction error coding process for the samples in the said CU. The CU may consist of a square block of samples with a size selectable from a predefined set of possible CU sizes. A CU with the maximum allowed size may be named as LCU (largest coding unit) or coding tree unit (CTU) and the video picture is divided into non-overlapping LCUs. An LCU can be further split into a combination of smaller CUs, e.g. by recursively splitting the LCU and resultant CUs. Each resulting CU may have at least one PU and at least one TU associated with it. Each PU and TU can be further split into smaller PUs and TUs in order to increase granularity of the prediction and prediction error coding processes, respectively. Each PU has prediction information associated with it defining what kind of a prediction is to be applied for the pixels within that PU (e.g. motion vector information for inter predicted PUs and intra prediction directionality information for intra predicted PUs).

Each TU can be associated with information describing the prediction error decoding process for the samples within the said TU (including e.g. DCT coefficient information). It may be signalled at CU level whether prediction error coding is applied or not for each CU. In the case there is no prediction error residual associated with the CU, it can be considered there are no TUs for the said CU. The division of the image into CUs, and division of CUs into PUs and TUs may be signalled in the bitstream allowing the decoder to reproduce the intended structure of these units.

In a draft version of H.266/VVC, the following partitioning applies. It is noted that what is described here might still evolve in later draft versions of H.266/VVC until the standard is finalized. Pictures are partitioned into CTUs similarly to HEVC, although the maximum CTU size has been increased to 128×128. A coding tree unit (CTU) is first partitioned by a quaternary tree (a.k.a. quadtree) structure. Then the quaternary tree leaf nodes can be further partitioned by a multi-type tree structure. There are four splitting types in multi-type tree structure, vertical binary splitting, horizontal binary splitting, vertical ternary splitting, and horizontal ternary splitting. The multi-type tree leaf nodes are called coding units (CUs). CU, PU and TU have the same block size, unless the CU is too large for the maximum transform length. A segmentation structure for a CTU is a quadtree with nested multi-type tree using binary and ternary splits, i.e. no separate CU, PU and TU concepts are in use except when needed for CUs that have a size too large for the maximum transform length. A CU can have either a square or rectangular shape.

A superblock in AV1 is similar to a CTU in VVC. A superblock may be regarded as the largest coding block that the AV1 specification supports. The size of the superblock is signaled in the sequence header to be 128×128 or 64×64 luma samples. A superblock may be partitioned into smaller coding blocks recursively. A coding block may have its own prediction and transform modes, independent of those of the other coding blocks.

The decoder reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence.

The filtering may for example include one more of the following: deblocking, sample adaptive offset (SAO), and/or adaptive loop filtering (ALF).

The deblocking loop filter may include multiple filtering modes or strengths, which may be adaptively selected based on the features of the blocks adjacent to the boundary, such as the quantization parameter value, and/or signaling included by the encoder in the bitstream. For example, the deblocking loop filter may comprise a normal filtering mode and a strong filtering mode, which may differ in terms of the number of filter taps (i.e. number of samples being filtered on both sides of the boundary) and/or the filter tap values. For example, filtering of two samples along both sides of the boundary may be performed with a filter having the impulse response of (3 7 9-3)/16, when omitting the potential impact of a clipping operation.

The motion information may be indicated with motion vectors associated with each motion compensated image block in video codecs. Each of these motion vectors represents the displacement of the image block in the picture to be coded (in the encoder side) or decoded (in the decoder side) and the prediction source block in one of the previously coded or decoded pictures. In order to represent motion vectors efficiently those may be coded differentially with respect to block specific predicted motion vectors. The predicted motion vectors may be created in a predefined way, for example calculating the median of the encoded or decoded motion vectors of the adjacent blocks. Another way to create motion vector predictions is to generate a list of candidate predictions from adjacent blocks and/or co-located blocks in temporal reference pictures and signaling the chosen candidate as the motion vector predictor. In addition to predicting the motion vector values, the reference index of previously coded/decoded picture can be predicted. The reference index may be predicted from adjacent blocks and/or co-located blocks in temporal reference picture. Moreover, high efficiency video codecs may employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information is carried out using the motion field information of adjacent blocks and/or co-located blocks in temporal reference pictures and the used motion field information is signaled among a list of motion field candidate list filled with motion field information of available adjacent/co-located blocks.

Video codecs may support motion compensated prediction from one source image (uni-prediction) and two sources (bi-prediction). In the case of uni-prediction a single motion vector is applied whereas in the case of bi-prediction two motion vectors are signaled and the motion compensated predictions from two sources are averaged to create the final sample prediction. In the case of weighted prediction, the relative weights of the two predictions can be adjusted, or a signaled offset can be added to the prediction signal.

In addition to applying motion compensation for inter picture prediction, similar approach can be applied to intra picture prediction. In this case the displacement vector indicates where from the same picture a block of samples can be copied to form a prediction of the block to be coded or decoded. This kind of intra block copying methods can improve the coding efficiency substantially in presence of repeating structures within the frame—such as text or other graphics.

The prediction residual after motion compensation or intra prediction may be first transformed with a transform kernel (like DCT) and then coded. The reason for this is that often there still exists some correlation among the residual and transform can in many cases help reduce this correlation and provide more efficient coding.

Video encoders may utilize Lagrangian cost functions to find optimal coding modes, e.g. the desired Macroblock mode and associated motion vectors. This kind of cost function uses a weighting factor λ to tie together the (exact or estimated) image distortion due to lossy coding methods and the (exact or estimated) amount of information that is required to represent the pixel values in an image area:

$$C = D + λ R \qquad ( Eq . l )$$

where C is the Lagrangian cost to be minimized, D is the image distortion (e.g. Mean Squared Error) with the mode and motion vectors considered, and R the number of bits needed to represent the required data to reconstruct the image block in the decoder (including the amount of data to represent the candidate motion vectors).

Some codecs use a concept of picture order count (POC). A value of POC is derived for each picture and is non-decreasing with increasing picture position in output order. POC therefore indicates the output order of pictures. POC may be used in the decoding process for example for implicit scaling of motion vectors and for reference picture list initialization. Furthermore, POC may be used in the verification of output order conformance.

In video coding standards, a compliant bit stream must be able to be decoded by a hypothetical reference decoder that may be conceptually connected to the output of an encoder and consists of at least a pre-decoder buffer, a decoder and an output/display unit. This virtual decoder may be known as the hypothetical reference decoder (HRD) or the video buffering verifier (VBV). A stream is compliant if it can be decoded by the HRD without buffer overflow or, in some cases, underflow. Buffer overflow happens if more bits are to be placed into the buffer when it is full. Buffer underflow happens if some bits are not in the buffer when said bits are to be fetched from the buffer for decoding/playback. One of the motivations for the HRD is to avoid so-called evil bitstreams, which would consume such a large quantity of resources that practical decoder implementations would not be able to handle.

HRD models may include instantaneous decoding, while the input bitrate to the coded picture buffer (CPB) of HRD may be regarded as a constraint for the encoder and the bitstream on decoding rate of coded data and a requirement for decoders for the processing rate. An encoder may include a CPB as specified in the HRD for verifying and controlling that buffering constraints are obeyed in the encoding. A decoder implementation may also have a CPB that may but does not necessarily operate similarly or identically to the CPB specified for HRD.

A Decoded Picture Buffer (DPB) may be used in the encoder and/or in the decoder. There may be two reasons to buffer decoded pictures, for references in inter prediction and for reordering decoded pictures into output order. Some coding formats, such as HEVC, provide a great deal of flexibility for both reference picture marking and output reordering, separate buffers for reference picture buffering and output picture buffering may waste memory resources. Hence, the DPB may include a unified decoded picture buffering process for reference pictures and output reordering. A decoded picture may be removed from the DPB when it is no longer used as a reference and is not needed for output. An HRD may also include a DPB. DPBs of an HRD and a decoder implementation may but do not need to operate identically.

Output order may be defined as the order in which the decoded pictures are output from the decoded picture buffer (for the decoded pictures that are to be output from the decoded picture buffer).

A decoder and/or an HRD may comprise a picture output process. The output process may be considered to be a process in which the decoder provides decoded and cropped pictures as the output of the decoding process. The output process may be a part of video coding standards, e.g. as a part of the hypothetical reference decoder specification. In output cropping, lines and/or columns of samples may be removed from decoded pictures according to a cropping rectangle to form output pictures. A cropped decoded picture may be defined as the result of cropping a decoded picture based on the conformance cropping window specified e.g. in the sequence parameter set that is referred to by the corresponding coded picture.

One or more syntax structures for (decoded) reference picture marking may exist in a video coding system. An encoder generates an instance of a syntax structure e.g. in each coded picture, and a decoder decodes an instance of the syntax structure e.g. from each coded picture. For example, the decoding of the syntax structure may cause pictures to be adaptively marked as “used for reference” or “unused for reference”.

A reference picture set (RPS) syntax structure of HEVC is an example of a syntax structure for reference picture marking. A reference picture set valid or active for a picture includes all the reference pictures that may be used as reference for the picture and all the reference pictures that are kept marked as “used for reference” for any subsequent pictures in decoding order. The reference pictures that are kept marked as “used for reference” for any subsequent pictures in decoding order but that are not used as reference picture for the current picture or image segment may be considered inactive. For example, they might not be included in the initial reference picture list(s).

In some coding formats and codecs, a distinction is made between so-called short-term and long-term reference pictures. This distinction may affect some decoding processes such as motion vector scaling. Syntax structure(s) for marking reference pictures may be indicative of marking a picture as “used for long-term reference” or “used for short-term reference”.

In some coding formats, reference picture for inter prediction may be indicated with an index to a reference picture list. In some codecs, two reference picture lists (reference picture list 0 and reference picture list 1) are generated for each bi-predictive (B) slice, and one reference picture list (reference picture list 0) is formed for each inter-coded (P) slice.

A reference picture list, such as the reference picture list 0 and the reference picture list 1, may be constructed in two steps: First, an initial reference picture list is generated. The initial reference picture list may be generated using an algorithm pre-defined in a standard. Such an algorithm may use e.g. POC and/or temporal sub-layer, as the basis. The algorithm may process reference pictures with particular marking(s), such as “used for reference”, and omit other reference pictures, i.e. avoid inserting other reference pictures into the initial reference picture list. An example of such other reference picture is a reference picture marked as “unused for reference” but still residing in the decoded picture buffer waiting to be output from the decoder. Second, the initial reference picture list may be reordered through a specific syntax structure, such as reference picture list reordering (RPLR) commands of H.264/AVC or reference picture list modification syntax structure of HEVC or anything alike. Furthermore, the number of active reference pictures may be indicated for each list, and the use of the pictures beyond the active ones in the list as reference for inter prediction is disabled. One or both the reference picture list initialization and reference picture list modification may process only active reference pictures among those reference pictures that are marked as “used for reference” or alike.

Scalable video coding refers to coding structure where one bitstream can contain multiple representations of the content at different bitrates, resolutions or frame rates. In these cases, the receiver can extract the desired representation depending on its characteristics (e.g. resolution that matches best the display device). Alternatively, a server or a network element can extract the portions of the bitstream to be transmitted to the receiver depending on e.g. the network characteristics or processing capabilities of the receiver. A scalable bitstream may include a “base layer” providing the lowest quality video available and one or more enhancement layers that enhance the video quality when received and decoded together with the lower layers. In order to improve coding efficiency for the enhancement layers, the coded representation of that layer may depend on the lower layers. E.g. the motion and mode information of the enhancement layer can be predicted from lower layers. Similarly, the pixel data of the lower layers can be used to create prediction for the enhancement layer.

A scalable video codec for quality scalability (also known as Signal-to-Noise or SNR) and/or spatial scalability may be implemented as follows. For a base layer, a conventional non-scalable video encoder and decoder is used. The reconstructed/decoded pictures of the base layer are included in the reference picture buffer for an enhancement layer. In H.264/AVC, HEVC, and similar codecs using reference picture list(s) for inter prediction, the base layer decoded pictures may be inserted into a reference picture list(s) for coding/decoding of an enhancement layer picture similarly to the decoded reference pictures of the enhancement layer. Consequently, the encoder may choose a base-layer reference picture as inter prediction reference and indicate its use e.g. with a reference picture index in the coded bitstream. The decoder decodes from the bitstream, for example from a reference picture index, that a base-layer picture is used as inter prediction reference for the enhancement layer. When a decoded base-layer picture is used as prediction reference for an enhancement layer, it is referred to as an inter-layer reference picture.

Scalability modes or scalability dimensions may include but are not limited to the following:
Quality scalability: Base layer pictures are coded at a lower quality than enhancement layer pictures, which may be achieved for example using a greater quantization parameter value (i.e., a greater quantization step size for transform coefficient quantization) in the base layer than in the enhancement layer.
Spatial scalability: Base layer pictures are coded at a lower resolution (i.e. have fewer samples) than enhancement layer pictures. Spatial scalability and quality scalability may sometimes be considered the same type of scalability.
Bit-depth scalability: Base layer pictures are coded at lower bit-depth (e.g. 8 bits) than enhancement layer pictures (e.g. 10 or 12 bits).
Dynamic range scalability: Scalable layers represent a different dynamic range and/or images obtained using a different tone mapping function and/or a different optical transfer function.
Chroma format scalability: Base layer pictures provide lower spatial resolution in chroma sample arrays (e.g. coded in 4:2:0 chroma format) than enhancement layer pictures (e.g. 4:4:4 format).
Color gamut scalability: enhancement layer pictures have a richer/broader color representation range than that of the base layer pictures—for example the enhancement layer may have UHDTV (ITU-R BT.2020) color gamut and the base layer may have the ITU-R BT.709 color gamut.
Region-of-interest (ROI) scalability: An enhancement layer represents of spatial subset of the base layer. ROI scalability may be used together with other types of scalability, e.g. quality or spatial scalability so that the enhancement layer provides higher subjective quality for the spatial subset.
View scalability, which may also be referred to as multiview coding. The base layer represents a first view, whereas an enhancement layer represents a second view.
Depth scalability, which may also be referred to as depth-enhanced coding. A layer or some layers of a bitstream may represent texture view(s), while other layer or layers may represent depth view(s).

In all of the above scalability cases, base layer information could be used to code enhancement layer to minimize the additional bitrate overhead.

Scalability can be enabled in two basic ways. Either by introducing new coding modes for performing prediction of pixel values or syntax from lower layers of the scalable representation or by placing the lower layer pictures to the reference picture buffer (decoded picture buffer, DPB) of the higher layer. The first approach is more flexible and thus can provide better coding efficiency in most cases. However, the second, reference frame-based scalability, approach can be implemented very efficiently with minimal changes to single layer codecs while still achieving majority of the coding efficiency gains available. Essentially a reference frame-based scalability codec can be implemented by utilizing the same hardware or software implementation for all the layers, just taking care of the DPB management by external means.

An elementary unit for the output of encoders of some coding formats, such as HEVC, and the input of decoders of some coding formats, such as HEVC, is a Network Abstraction Layer (NAL) unit. For transport over packet-oriented networks or storage into structured files, NAL units may be encapsulated into packets or similar structures.

NAL units consist of a header and payload. In HEVC, a two-byte NAL unit header is used for all specified NAL unit types, while in other codecs NAL unit header may be similar to that in HEVC.

In HEVC, the NAL unit header contains one reserved bit, a six-bit NAL unit type indication, a three-bit temporal_id_plus1 indication for temporal level or sub-layer (may be required to be greater than or equal to 1) and a six-bit nuh_layer_id syntax element. The temporal_id_plus1 syntax element may be regarded as a temporal identifier for the NAL unit, and a zero-based TemporalId variable may be derived as follows: TemporalId=temporal_id_plus1-1. The abbreviation TID may be used to interchangeably with the TemporalId variable. TemporalId equal to 0 corresponds to the lowest temporal level. The value of temporal_id_plus1 is required to be non-zero in order to avoid start code emulation involving the two NAL unit header bytes. The bitstream created by excluding all VCL NAL units having a TemporalId greater than or equal to a selected value and including all other VCL NAL units remains conforming. Consequently, a picture having TemporalId equal to tid_value does not use any picture having a TemporalId greater than tid_value as inter prediction reference. A sub-layer or a temporal sub-layer may be defined to be a temporal scalable layer (or a temporal layer, TL) of a temporal scalable bitstream. Such temporal scalable layer may comprise VCL NAL units with a particular value of the TemporalId variable and the associated non-VCL NAL units. nuh_layer_id can be understood as a scalability layer identifier.

NAL units can be categorized into Video Coding Layer (VCL) NAL units and non-VCL NAL units. VCL NAL units may be coded slice NAL units. In HEVC, VCL NAL units contain syntax elements representing one or more CU. In HEVC, the NAL unit type within a certain range indicates a VCL NAL unit, and the VCL NAL unit type indicates a picture type.

In some coding formats, such as AV1, a bitstream may comprise a sequence of open bitstream units (OBUs). An OBU comprises a header and a payload, wherein the header identifies a type of the OBU. Furthermore, the header may comprise a size of the payload in bytes.

Images can be split into independently codable and decodable image segments (e.g. slices or tiles or tile groups). Such image segments may enable parallel processing. Image segments may be coded as separate units in the bitstream, such as VCL NAL units in H.264/AVC and HEVC. Coded image segments may comprise a header and a payload, wherein the header contains parameter values needed for decoding the payload.

In some video coding formats, such as HEVC and VVC, a picture can be partitioned in tiles, which are rectangular and contain an integer number of CTUs. The partitioning to tiles forms a grid that may be characterized by a list of tile column widths (in CTUs) and a list of tile row heights (in CTUs). For encoding and/or decoding, the CTUs in a tile are scanned in raster scan order within that tile. In HEVC, tiles are ordered in the bitstream consecutively in the raster scan order of the tile grid.

In some video coding formats, such as AV1, a picture may be partitioned into tiles, and a tile consists of an integer number of complete superblocks that collectively form a complete rectangular region of a picture. In-picture prediction across tile boundaries is disabled. The minimum tile size is one superblock, and the maximum tile size in the presently specified levels in AV1 is 4096×2304 in terms of luma sample count. The picture is partitioned into a tile grid of one or more tile rows and one or more tile columns. The tile grid may be signaled in the picture header to have a uniform tile size or nonuniform tile size, where in the latter case the tile row heights and tile column widths are signaled. The superblocks in a tile are scanned in raster scan order within that tile.

In some video coding formats, such as VVC, a slice consists of an integer number of complete tiles or an integer number of consecutive complete CTU rows within a tile of a picture. Consequently, each vertical slice boundary is always also a vertical tile boundary. It is possible that a horizontal boundary of a slice is not a tile boundary but consists of horizontal CTU boundaries within a tile; this occurs when a tile is split into multiple rectangular slices, each of which consists of an integer number of consecutive complete CTU rows within the tile.

In some video coding formats, such as VVC, two modes of slices are supported, namely the raster-scan slice mode and the rectangular slice mode. In the raster-scan slice mode, a slice contains a sequence of complete tiles in a tile raster scan of a picture. In the rectangular slice mode, a slice contains either a number of complete tiles that collectively form a rectangular region of the picture or a number of consecutive complete CTU rows of one tile that collectively form a rectangular region of the picture. Tiles within a rectangular slice are scanned in tile raster scan order within the rectangular region corresponding to that slice.

In HEVC, a slice consists of an integer number of CTUs. The CTUs are scanned in the raster scan order of CTUs within tiles or within a picture, if tiles are not in use. A slice may contain an integer number of tiles or a slice can be contained in a tile. Within a CTU, the CUs have a specific scan order.

In HEVC, a slice is defined to be an integer number of coding tree units contained in one independent slice segment and all subsequent dependent slice segments (if any) that precede the next independent slice segment (if any) within the same access unit. In HEVC, a slice segment is defined to be an integer number of coding tree units ordered consecutively in the tile scan and contained in a single NAL (Network Abstraction Layer) unit. The division of each picture into slice segments is a partitioning. In HEVC, an independent slice segment is defined to be a slice segment for which the values of the syntax elements of the slice segment header are not inferred from the values for a preceding slice segment, and a dependent slice segment is defined to be a slice segment for which the values of some syntax elements of the slice segment header are inferred from the values for the preceding independent slice segment in decoding order. In HEVC, a slice header is defined to be the slice segment header of the independent slice segment that is a current slice segment or is the independent slice segment that precedes a current dependent slice segment, and a slice segment header is defined to be a part of a coded slice segment containing the data elements pertaining to the first or all coding tree units represented in the slice segment. The CUs are scanned in the raster scan order of LCUs within tiles or within a picture, if tiles are not in use. Within an LCU, the CUs have a specific scan order.

In some video coding formats, such as AV1, a tile group OBU carries one or more complete tiles. The first and last tiles of in the tile group OBU may be indicated in the tile group OBU before the coded tile data. Tiles within a tile group OBU may appear in a tile raster scan of a picture.

A motion-constrained tile set (MCTS) is such that the inter prediction process is constrained in encoding such that no sample value outside the motion-constrained tile set, and no sample value at a fractional sample position that is derived using one or more sample values outside the motion-constrained tile set, is used for inter prediction of any sample within the motion-constrained tile set. Additionally, the encoding of an MCTS is constrained in a manner that motion vector candidates are not derived from blocks outside the MCTS. This may be enforced by turning off temporal motion vector prediction of HEVC, or by disallowing the encoder to use the TMVP candidate or any motion vector prediction candidate following the TMVP candidate in the merge or AMVP candidate list for PUs located directly left of the right tile boundary of the MCTS except the last one at the bottom right of the MCTS. In general, an MCTS may be defined to be a tile set that is independent of any sample values and coded data, such as motion vectors, that are outside the MCTS. An MCTS sequence may be defined as a sequence of respective MCTSs in one or more coded video sequences or alike. In some cases, an MCTS may be required to form a rectangular area. It should be understood that depending on the context, an MCTS may refer to the tile set within a picture or to the respective tile set in a sequence of pictures. The respective tile set may be, but in general need not be, collocated in the sequence of pictures. A motion-constrained tile set may be regarded as an independently coded tile set, since it may be decoded without the other tile sets.

It is appreciated that sample locations used in inter prediction may be saturated so that a location that would be outside the picture otherwise is saturated to point to the corresponding boundary sample of the picture. Hence, in some use cases, if a tile boundary is also a picture boundary, motion vectors may effectively cross that boundary or a motion vector may effectively cause fractional sample interpolation that would refer to a location outside that boundary, since the sample locations are saturated onto the boundary. In other use cases, specifically if a coded tile may be extracted from a bitstream where it is located on a position adjacent to a picture boundary to another bitstream where the tile is located on a position that is not adjacent to a picture boundary, encoders may constrain the motion vectors on picture boundaries similarly to any MCTS boundaries.

The temporal motion-constrained tile sets SEI (Supplemental Enhancement Information) message of HEVC can be used to indicate the presence of motion-constrained tile sets in the bitstream.

In wavefront parallel processing (WPP) each block row (such as CTU row in HEVC) of an image segment can be encoded and decoded in parallel. When WPP is used, the state of the entropy codec at the beginning of a block row is obtained from the state of the entropy codec of the block row above after processing a certain block, such as the second block, of that row. Consequently, block rows can be processed in parallel with a delay of a certain number of blocks (e.g. 2 blocks) per each block row. In other words, the processing of the current block row can be started when the processing of the block with certain index of the previous block row has been finished. The same or similar difference between decoding block rows is kept throughout the block row due to potential prediction dependencies, such as directional intra prediction from the upper right block. Thanks to WPP property, block rows can be processed in a parallel fashion. In general, it may be pre-defined e.g. in a coding standard which CTU is used for transferring the entropy (de)coding state of the previous row of CTUs or it may be determined and indicated in the bitstream by the encoder and/or decoded from the bitstream by the decoder. Wavefront parallel processing with a delay less than 2 blocks may require constraining some prediction modes so that prediction from above and right side of the current block is avoided. The per-block-row delay of wavefronts may be pre-defined, e.g. in a coding standard, and/or indicated by the encoder in or along the bitstream, and/or concluded by the decoder from or along the bitstream.

WPP processes rows of coding tree units (CTU) in parallel while preserving all coding dependencies. In WPP, entropy coding, predictive coding as well as in-loop filtering can be applied in a single processing step, which makes the implementations of WPP rather straightforward.

When a coded picture has been constrained for wavefront processing or when tiles have been used, CTU rows or tiles (respectively) may be byte-aligned in the bitstream and may be preceded by a start code. Additionally, entry points may be provided in the bitstream (e.g. in the slice header) and/or externally (e.g. in a container file). An entry point is a byte pointer or a byte count or a similar straightforward reference mechanism to the start of a CTU row (for wavefront-enabled coded pictures) or a tile. In HEVC, entry points may be specified using entry_point_offset_minus1[i] of the slice header.

A non-VCL NAL unit may be for example one of the following types: a sequence parameter set, a picture parameter set, a supplemental enhancement information (SEI) NAL unit, an access unit delimiter, an end of sequence NAL unit, an end of bitstream NAL unit, or a filler data NAL unit. Parameter sets may be needed for the reconstruction of decoded pictures, whereas many of the other non-VCL NAL units are not necessary for the reconstruction of decoded sample values.

Some coding formats specify parameter sets that may carry parameter values needed for the decoding or reconstruction of decoded pictures. Parameters that remain unchanged through a coded video sequence may be included in a sequence parameter set (SPS). In addition to the parameters that may be needed by the decoding process, the sequence parameter set may optionally contain video usability information (VUI), which includes parameters that may be important for buffering, picture output timing, rendering, and resource reservation. A picture parameter set (PPS) contains such parameters that are likely to be unchanged in several coded pictures. A picture parameter set may include parameters that can be referred to by the coded image segments of one or more coded pictures. A header parameter set (HPS) has been proposed to contain such parameters that may change on picture basis.

A parameter set may be activated when it is referenced e.g. through its identifier. For example, a header of an image segment, such as a slice header, may contain an identifier of the PPS that is activated for decoding the coded picture containing the image segment. A PPS may contain an identifier of the SPS that is activated, when the PPS is activated. An activation of a parameter set of a particular type may cause the deactivation of the previously active parameter set of the same type.

Instead of or in addition to parameter sets at different hierarchy levels (e.g. sequence and picture), video coding formats may include header syntax structures, such as a sequence header or a picture header. A sequence header may precede any other data of the coded video sequence in the bitstream order. A picture header may precede any coded video data for the picture in the bitstream order.

The phrase along the bitstream (e.g. indicating along the bitstream) or along a coded unit of a bitstream (e.g. indicating along a coded tile) may be used in claims and described embodiments to refer to transmission, signaling, or storage in a manner that the “out-of-band” data is associated with but not included within the bitstream or the coded unit, respectively. The phrase decoding along the bitstream or along a coded unit of a bitstream or alike may refer to decoding the referred out-of-band data (which may be obtained from out-of-band transmission, signaling, or storage) that is associated with the bitstream or the coded unit, respectively. For example, the phrase along the bitstream may be used when the bitstream is contained in a container file, such as a file conforming to the ISO Base Media File Format, and certain file metadata is stored in the file in a manner that associates the metadata to the bitstream, such as boxes in the sample entry for a track containing the bitstream, a sample group for the track containing the bitstream, or a timed metadata track associated with the track containing the bitstream.

A coded picture is a coded representation of a picture.

A Random Access Point (RAP) picture, which may also be referred to as an intra random access point (IRAP) picture, may comprise only intra-coded image segments. Furthermore, a RAP picture may constrain subsequence pictures in output order to be such that they can be correctly decoded without performing the decoding process of any pictures that precede the RAP picture in decoding order.

An access unit may comprise coded video data for a single time instance and associated other data. In HEVC, an access unit (AU) may be defined as a set of NAL units that are associated with each other according to a specified classification rule, are consecutive in decoding order, and contain at most one picture with any specific value of nuh_layer_id. In addition to containing the VCL NAL units of the coded picture, an access unit may also contain non-VCL NAL units. Said specified classification rule may for example associate pictures with the same output time or picture output count value into the same access unit.

It may be required that coded pictures appear in certain order within an access unit. For example, a coded picture with nuh_layer_id equal to nuhLayerIdA may be required to precede, in decoding order, all coded pictures with nuh_layer_id greater than nuhLayerIdA in the same access unit.

A bitstream may be defined as a sequence of bits, which may in some coding formats or standards be in the form of a NAL unit stream or a byte stream, that forms the representation of coded pictures and associated data forming one or more coded video sequences. A first bitstream may be followed by a second bitstream in the same logical channel, such as in the same file or in the same connection of a communication protocol. An elementary stream (in the context of video coding) may be defined as a sequence of one or more bitstreams. In some coding formats or standards, the end of the first bitstream may be indicated by a specific NAL unit, which may be referred to as the end of bitstream (EOB) NAL unit and which is the last NAL unit of the bitstream.

A coded video sequence (CVS) may be defined as such a sequence of coded pictures in decoding order that is independently decodable and is followed by another coded video sequence or the end of the bitstream.

Bitstreams or coded video sequences can be encoded to be temporally scalable as follows. Each picture may be assigned to a particular temporal sub-layer. Temporal sub-layers may be enumerated e.g. from 0 upwards. The lowest temporal sub-layer, sub-layer 0, may be decoded independently. Pictures at temporal sub-layer 1 may be predicted from reconstructed pictures at temporal sub-layers 0 and 1. Pictures at temporal sub-layer 2 may be predicted from reconstructed pictures at temporal sub-layers 0, 1, and 2, and so on. In other words, a picture at temporal sub-layer N does not use any picture at temporal sub-layer greater than N as a reference for inter prediction. The bitstream created by excluding all pictures greater than or equal to a selected sub-layer value and including pictures remains conforming.

A sub-layer access picture may be defined as a picture from which the decoding of a sub-layer can be started correctly, i.e. starting from which all pictures of the sub-layer can be correctly decoded. In HEVC there are two picture types, the temporal sub-layer access (TSA) and step-wise temporal sub-layer access (STSA) picture types, that can be used to indicate temporal sub-layer switching points. If temporal sub-layers with TemporalId up to N had been decoded until the TSA or STSA picture (exclusive) and the TSA or STSA picture has TemporalId equal to N+1, the TSA or STSA picture enables decoding of all subsequent pictures (in decoding order) having TemporalId equal to N+1. The TSA picture type may impose restrictions on the TSA picture itself and all pictures in the same sub-layer that follow the TSA picture in decoding order. None of these pictures is allowed to use inter prediction from any picture in the same sub-layer that precedes the TSA picture in decoding order. The TSA definition may further impose restrictions on the pictures in higher sub-layers that follow the TSA picture in decoding order. None of these pictures is allowed to refer a picture that precedes the TSA picture in decoding order if that picture belongs to the same or higher sub-layer as the TSA picture. TSA pictures have TemporalId greater than 0. The STSA is similar to the TSA picture but does not impose restrictions on the pictures in higher sub-layers that follow the STSA picture in decoding order and hence enable up-switching only onto the sub-layer where the STSA picture resides.

Available media file format standards include ISO base media file format (ISO/IEC 14496-12, which may be abbreviated ISOBMFF), MPEG-4 file format (ISO/IEC 14496-14, also known as the MP4 format), file format for NAL unit structured video (ISO/IEC 14496-15) and 3GPP file format (3GPP TS 26.244, also known as the 3GP format). The ISO file format is the base for derivation of all the above mentioned file formats (excluding the ISO file format itself). These file formats (including the ISO file format itself) are generally called the ISO family of file formats.

Some concepts, structures, and specifications of ISOBMFF are described below as an example of a container file format, based on which the embodiments may be implemented. The aspects of the invention are not limited to ISOBMFF, but rather the description is given for one possible basis on top of which the invention may be partly or fully realized.

A basic building block in the ISO base media file format is called a box. Each box has a header and a payload. The box header indicates the type of the box and the size of the box in terms of bytes. A box may enclose other boxes, and the ISO file format specifies which box types are allowed within a box of a certain type. Furthermore, the presence of some boxes may be mandatory in each file, while the presence of other boxes may be optional. Additionally, for some box types, it may be allowable to have more than one box present in a file. Thus, the ISO base media file format may be considered to specify a hierarchical structure of boxes.

According to the ISO family of file formats, a file includes media data and metadata that are encapsulated into boxes. Each box is identified by a four character code (4CC) and starts with a header which informs about the type and size of the box.

In files conforming to the ISO base media file format, the media data may be provided in a media data ‘mdat’ box and the movie ‘moov’ box may be used to enclose the metadata. In some cases, for a file to be operable, both of the ‘mdat’ and ‘moov’ boxes may be required to be present. The movie ‘moov’ box may include one or more tracks, and each track may reside in one corresponding TrackBox (‘trak’). A track may be one of the many types, including a media track that refers to samples formatted according to a media compression format (and its encapsulation to the ISO base media file format). A track may be regarded as a logical channel.

Movie fragments may be used e.g. when recording content to ISO files e.g. in order to avoid losing data if a recording application crashes, runs out of memory space, or some other incident occurs. Without movie fragments, data loss may occur because the file format may require that all metadata, e.g., the movie box, be written in one contiguous area of the file. Furthermore, when recording a file, there may not be sufficient amount of memory space (e.g., random access memory RAM) to buffer a movie box for the size of the storage available, and re-computing the contents of a movie box when the movie is closed may be too slow. Moreover, movie fragments may enable simultaneous recording and playback of a file using a regular ISO file parser. Furthermore, a smaller duration of initial buffering may be required for progressive downloading, e.g., simultaneous reception and playback of a file when movie fragments are used, and the initial movie box is smaller compared to a file with the same media content but structured without movie fragments.

The movie fragment feature may enable splitting the metadata that otherwise might reside in the movie box into multiple pieces. Each piece may correspond to a certain period of time of a track. In other words, the movie fragment feature may enable interleaving file metadata and media data. Consequently, the size of the movie box may be limited, and the use cases mentioned above be realized.

In some examples, the media samples for the movie fragments may reside in an mdat box, if they are in the same file as the moov box. For the metadata of the movie fragments, however, a moof box may be provided. The moof box may include the information for a certain duration of playback time that would previously have been in the moov box. The moov box may still represent a valid movie on its own, but in addition, it may include an mvex box indicating that movie fragments will follow in the same file. The movie fragments may extend the presentation that is associated to the moov box in time.

Within the movie fragment there may be a set of track fragments, including anywhere from zero to a plurality per track. The track fragments may in turn include anywhere from zero to a plurality of track runs (a.k.a. track fragment runs), each of which document is a contiguous run of samples for that track. Within these structures, many fields are optional and can be defaulted. The metadata that may be included in the moof box may be limited to a subset of the metadata that may be included in a moov box and may be coded differently in some cases. Details regarding the boxes that can be included in a moof box may be found from the ISO base media file format specification. A self-contained movie fragment may be defined to consist of a moof box and an mdat box that are consecutive in the file order and where the mdat box contains the samples of the movie fragment (for which the moof box provides the metadata) and does not contain samples of any other movie fragment (i.e. any other moof box).

The track reference mechanism can be used to associate tracks with each other. The TrackReferenceBox includes box(es), each of which provides a reference from the containing track to a set of other tracks. These references are labeled through the box type (i.e. the four-character code of the box) of the contained box(es).

TrackGroupBox, which is contained in TrackBox, enables indication of groups of tracks where each group shares a particular characteristic or the tracks within a group have a particular relationship. The box contains zero or more boxes, and the particular characteristic or the relationship is indicated by the box type of the contained boxes. The contained boxes include an identifier, which can be used to conclude the tracks belonging to the same track group. The tracks that contain the same type of a contained box within the TrackGroupBox and have the same identifier value within these contained boxes belong to the same track group.

A coded video sequence may comprise intra coded pictures (i.e. I pictures) and inter coded pictures (e.g. P and B pictures). Intra coded pictures may use many more bits than inter coded pictures. Transmission time of such large (in size) intra coded pictures increases the encoder to decoder delay.

For (ultra) low delay applications, it may be desirable that both the intra coded pictures and the inter coded pictures have similar number of bits so that the encoder to decoder delay can be reduced to around 1 picture interval. It is appreciated that intra coded picture are not suitable for (ultra) low delay applications because of the long encoder to decoder delay. However, an intra coded picture is needed at random access point.

Gradual Decoding Refresh (GDR) which is also known as Gradual random access (GRA) or Progressive Intra Refresh (PIR), alleviates the delay issue with intra coded pictures. Instead of coding an intra picture at a random access point, GDR progressively refreshes pictures by spreading intra coded regions (groups of intra coded blocks) over several pictures.

Pictures within the GDR period (also referred to as a “refresh period”), i.e. pictures from the random access point (inclusive) to the recovery point (exclusive), may be considered to have at least two regions, a refreshed region, which may also be called as a “clean” region, and a non-refreshed region, which may also be called a “dirty” region. The refreshed region can be correctly decoded when the decoding is started from the random access point, while the decoded “dirty” region might not be correct in content when the decoding is started from the random access point. The refreshed region may only be inter-predicted from refreshed regions of the reference pictures within the same refresh period, i.e. parameters or sample values of the “dirty” region are not used in inter prediction of the refreshed region. Since the refreshed region in a picture may be larger than the refreshed region in the previous pictures, the intra coding may be used for the coding block locations that are newly added in the refreshed region compared to the refreshed regions of earlier pictures in the same refresh period.

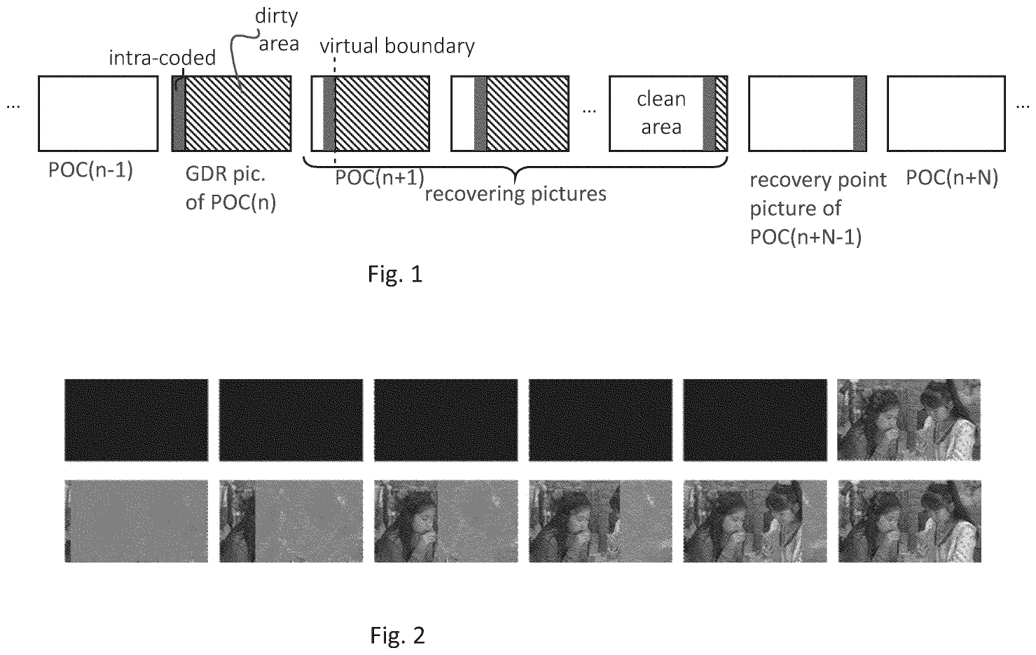

FIG. 1 illustrates an example of a basic concept of a vertical GDR, where a GDR period starts with picture of POC(n) and ends with picture of POC(n+N−1), including N pictures in total. The first picture POC(n) within the GDR period is called GDR picture. Forced intra coded areas (grey) gradually spread over consecutive pictures of the GDR period from the left to the right on a picture-by-picture basis. A white area represents clean area which is gradually expanded vertically from left to the right. The first picture when a picture is complete i.e. the picture at POC(n+N−1) is completely intra refreshed, and it is called a recovery point picture. The pictures between GDR picture of POC(n) and recovery point picture of POC(n+N−1) are called recovering pictures of GDR picture of POC(n). The lined area in FIG. 1 represents a dirty area.

A current picture within a GDR period may consist of a clean (or refreshed) area and a dirty (or non-refreshed) area, where the clean area may contain a forced intra area next to the dirty area for progressive intra refresh (PIR), as shown in picture of POC(n+1) of FIG. 1.

In VVC, the boundary between clean area and dirty area may be signalled by a virtual boundary syntax in the Picture Header.

Many video coding specifications require the encoding of the clean area to be constrained so that no parameters or sample values of the dirty area in the current picture or any reference picture are used for decoding the clean area. For example, encoding of the clean areas is constrained not to use any prediction from the dirty areas of the current picture and the reference pictures. For example, motion vectors are limited so that the prediction block for a coding unit or block in clean area only uses samples within the clean area in the reference picture. In another example, temporal motion vector candidates from dirty area are avoided.

A decoder and/or a hypothetical reference decoder (HRD) may comprise a picture output process. The output process may be considered to be a process in which the decoder provides decoded and cropped pictures as the output of the decoding process. The output process is typically a part of video coding standards, typically as a part of the hypothetical reference decoder specification. In output cropping, lines and/or columns of samples may be removed from decoded pictures according to a cropping rectangle to form output pictures. A cropped decoded picture may be defined as the result of cropping a decoded picture based on the conformance cropping window specified e.g. in the sequence parameter set or the picture parameter set that is referred to by the corresponding coded picture.

In VVC, pps_pic_width_in_luma_samples specifies the width of each decoded picture referring to the PPS in units of luma samples. pps_pic_height_in_luma_samples specifies the height of each decoded picture referring to the PPS in units of luma samples.

In VVC, pps_conf_win_left_offset, pps_conf_win_right_offset, pps_conf_win_top_offset, and pps_conf_win_bottom_offset specify the samples of the picture that are output from the decoding process, in terms of a rectangular region specified in picture coordinates for output.

pps_conf_win_left_offset indicates the number of sample columns outside the conformance cropping window at the left edge of the decoded picture.

pps_conf_win_right_offset indicates the number of sample columns outside the conformance cropping window at the right edge of the decoded picture.

pps_conf_win_top_offset indicates the number of sample columns outside the conformance cropping window at the top edge of the decoded picture.

pps_conf_win_bottom_offset indicates the number of sample columns outside the conformance cropping window at the bottom edge of the decoded picture.

In VVC, pps_conf_win_left_offset, pps_conf_win_right_offset, pps_conf_win_top_offset, and pps_conf_win_bottom_offset use a unit of a single luma sample in monochrome (4:0:0) and 4:4:4 chroma formats, a unit of 2 luma samples in the 4:2:0 chroma format, and a unit of 2 luma samples is used for pps_conf_win_left_offset and pps_conf_win_right_offset, and a unit of 1 luma sample for pps_conf_win_top_offset and pps_conf_win_bottom_offset in the 4:2:2 chroma format.

In VVC, the conformance cropping window implicitly sets the scaling window, and hence enables maintaining the correspondence of sample locations between the current picture and its reference pictures correctly.

History-based motion vector prediction (HMVP) may be summarized as follows. A list of HMVP candidates is derived by adding each coded motion vector into the list. If the list is fully occupied, the oldest HMVP candidate is removed from the list. HMVP candidate(s) may be inserted into the candidate lists for motion vector prediction, such as the merge mode in VVC.

When the boundary between clean and dirty areas of GDR is not aligned with a CTU boundary, the encoding may need to be further constrained in one or more of the following ways:
Block partitioning must be selected so that no coding unit crosses the boundary between clean and dirty areas.
Chroma residual scaling of luma mapping with chroma scaling (LMCS) has to be disabled.
Spatial candidates, affine merge candidates and HMVP candidates originating from the dirty area need to be avoided.
Intra block copy from samples in the dirty area need to be avoided.

These encoding constraints are complex, and the respective encoder source code changes are substantial. The above-listed encoding limitations are not necessary and the respective encoder source code for GDR is simpler, when the boundary between the clean and dirty areas is CTU-aligned. However, gradual decoding refresh with a CTU-aligned boundary between the clean and dirty areas is relatively coarse and may still cause a substantial bitrate variation due to a relatively large portion of the picture being intra-coded.

With the current design of VVC, it is the encoder's responsibility to achieve exact match at recovery point for GDR applications. Encoder should make sure that CUs in a clean area will not use any coding information from dirty areas.

Practically, a VVC encoder with GDR functionality may need to impose the necessary restrictions on almost all the possible coding tools for CUs in clean area and make sure they will not touch any coding information in dirty area. Those coding tools may include in-loop filters, intra prediction modes (directions), intra block copy (IBC), regular inter modes with integer or fractional motion vectors, all possible merge modes, such as Regular Merge mode, Affine, combined inter-intra prediction (CIIP), merge mode with motion vector difference (MMVD), Triangle or geometric merge mode (GEO), temporal motion vector prediction (TMVP), history-based motion vector prediction (HMVP), etc., and special coding tools, such as LMCS, Local Dual Tree, etc.

With the current design of VVC, for example the following constraints should be taken into account.
For intra CUs in clean area, encoder with GDR functionality needs to check the possible intra prediction modes and avoid those that will use any reference samples in dirty area of the current picture.
For inter CUs in clean-area, encoder with GDR functionality needs to check the (interpolated) prediction blocks and make sure that they will not use any reconstructed pixels in dirty areas of reference pictures.
For merge mode CUs in clean area, encoder with GDR functionality needs to check and make sure that if a merge candidate in merge candidate list is associated with dirty areas, the merge candidate and the other following merge candidates in merge candidate list and AMVP candidate list will not be selected.
For clean-area CUs with multiple PUs (affine, GPM, SbTMVP), encoder with GDR functionality needs to check and make sure that the (interpolated) prediction blocks for each of PUs within the CU will not use any reconstructed pixels in dirty areas of reference pictures.
With inter CUs in clean area, if HMVP is to be included in the merge list, encoder with GDR functionality needs to avoid selecting the candidates associated with CUs in dirty area of the current picture. For IBC mode CUs in clean area, encoder with GDR functionality needs to check and make sure that IBC does not include any pixels in dirty area.
The in-loop filters in VVC, including deblocking, SAO and ALF, use the pixels on both sides of a virtual boundary, implying the pixels of CUs in dirty area will contaminate the pixels of CUs in clean area. Hence, encoder with GDR functionality will have to disable the in-loop filters at the virtual boundaries in order to avoid the clean area being contaminated by the dirty area.
For LMCS, encoder may have to disable chroma residual scaling process to avoid use of the reconstructed luma pixels in dirty area [4], which may affect the quality of chroma components.

It may be complicated and costly to impose the restrictions on coding tools for CUs in a clean area, which will likely lead to an expensive encoder with GDR functionality, as compared to a regular encoder. In addition, constraints on coding tools will likely affect the coding efficiency.

According to an embodiment, boundaries (e.g. virtual boundary) between clean (refreshed) areas and dirty (non-refreshed) areas of pictures may be treated similarly to “picture boundaries” for CUs in clean (refreshed) area of a current picture and similarly to “no boundaries” for CUs in dirty (non-refreshed) area of the current picture. One or more of the following may be applied for inter CUs in clean area of a current picture.
The reconstructed pixels in dirty areas of reference pictures are considered as “not available”, and if needed, they are padded from the reconstructed pixels in clean areas of reference pictures (or set to a pre-determined value, e.g. 2^{BD-1} where BD is the bit depth), which may give predictions of CUs in clean area of the current picture more freedom over the reference pictures, instead of being limited to the clean areas of reference pictures.
The coding information in dirty areas of reference pictures are considered “not available” or “not inter mode”, which will prevent CUs in clean area of the current picture from using the coding information in dirty areas of reference pictures.
The coding information in dirty area of the current picture are also considered “not available”, which will prevent inter modes (e.g. merge mode, AMVP, HMVP, affine), and other possible modes (e.g. IBC merge and IBC HMVP) from using coding information in dirty areas of the current picture.

In some embodiments, in-loop filtering across the boundary between the dirty area and the clean area is controlled as follows.
For pixels on the dirty-area side of the boundary, in-loop filters are enabled normally, as if there was no boundary. In-loop filters are allowed to use the coding information (e.g. recon pixels, code mode, refIdx, MVs, etc.) in both the clean and dirty areas.
For pixels on the clean-area side of the boundary, in-loop filters are also enabled, but in-loop filters are not allowed to use the coding information in the dirty area. The coding information in dirty area are considered as “not available” and when needed, they are padded (or derived) from the clean area or pre-set.

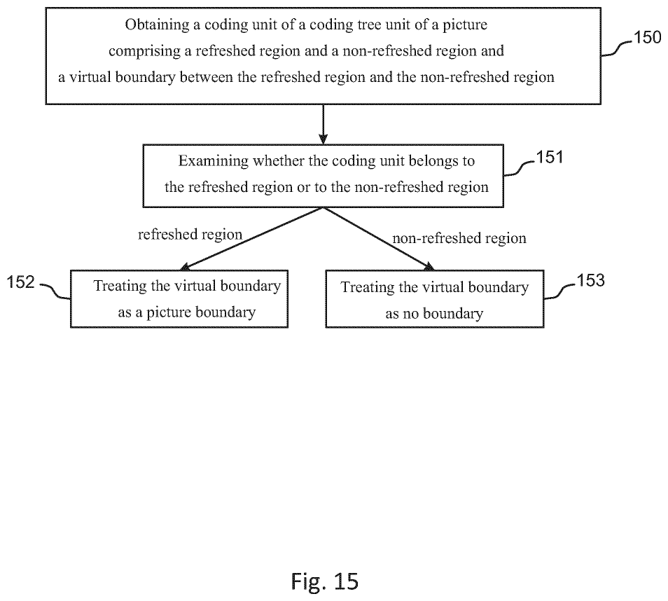

The method according to an embodiment is shown in FIG. 15. The method generally comprises obtaining 150 a coding unit of a coding tree unit of a picture comprising a refreshed region and a non-refreshed region and a virtual boundary between the refreshed region and the non-refreshed region; examining 151 whether the coding unit belongs to the refreshed region or to the non-refreshed region; treating 152 the virtual boundary as a picture boundary when determining that the coding unit belongs to the refreshed region; or treating 153 the virtual boundary as no boundary when determining that the coding unit belongs to the non-refreshed region. Each of the steps can be implemented by a respective module of a computer system.

An apparatus according to an embodiment comprises means for obtaining a coding unit of a coding tree unit of a picture comprising a refreshed region and a non-refreshed region and a virtual boundary between the refreshed region and the non-refreshed region; means for examining whether the coding unit belongs to the refreshed region or to the non-refreshed region; means for treating the virtual boundary as a picture boundary when determining that the coding unit belongs to the refreshed region; and means for treating the virtual boundary as no boundary when determining that the coding unit belongs to the non-refreshed region. The means comprises at least one processor, and a memory including a computer program code, wherein the processor may further comprise processor circuitry. The memory and the computer program code are configured to, with the at least one processor, cause the apparatus to perform the method of encoding/decoding video information according to various embodiments.

In the current VVC design, decoding can start at either an IRAP picture or a GDR picture. If decoding starts at a GDR picture, the GDR picture and associated recovering pictures are not output. This means that the users will have to wait until a recovery point picture is decoded, as shown in the top set of pictures of FIG. 2. For example, if a GDR period lasts one second, users need to wait for one second to see the first completely decoded picture.

In the following, some embodiments will be described in more detail.

In accordance with some embodiments, output of GDR/recovering pictures may be possible even if decoding starts at a GDR picture. Therefore, users may be able to view any GDR picture and associated recovering pictures, even though they may only be partially refreshed, as shown in the bottom set of pictures of FIG. 2.

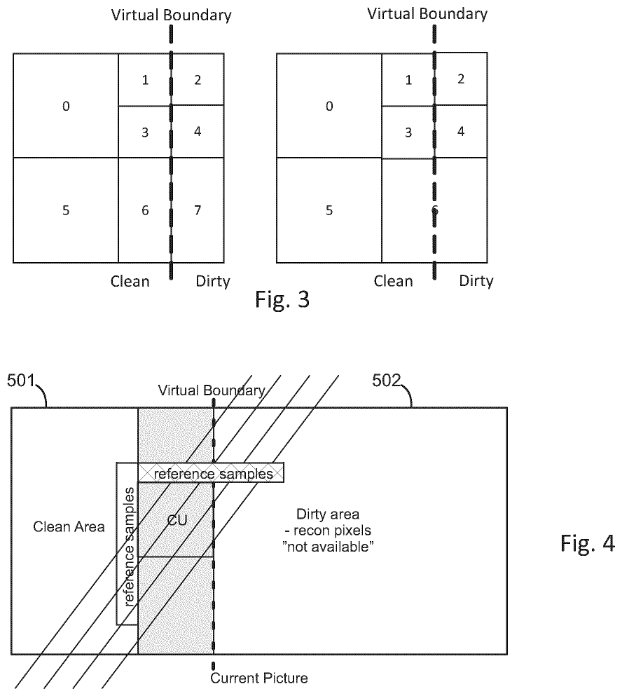

In accordance with some embodiments, all types of partitions within a current CTU may be allowed, but no CU should span both the clean area and the dirty area. For example, FIG. 3 shows two mixed-area CTUs, where the dotted lines illustrate virtual boundaries. In the CTU on the left, no CU crosses the virtual boundary or spans both clean area and dirty area. However, in the CTU on the right, the CU which is labelled with the number 6 contains pixels in both clean area and dirty area, which is should be avoided in the described embodiments.

The virtual boundary has no impact on signaling CTU partition structure or on the coding order of CUs within a CTU.

In the following, some aspects regarding CU Coding will be described.

In order to remove the constraints on coding tools without leaks, a few normative modifications to the current VVC specification for GDR will be presented as follows. For CUs in a clean area of a current picture, virtual boundaries between clean areas and dirty areas are treated, similarly, as “picture boundaries”, and for CUs in a dirty area of the current picture, virtual boundaries between clean areas and dirty areas are treated as no boundaries.

With the above modifications, the constraints imposed on coding tools for encoder with GDR functionality under the current VVC specification become unnecessary.

The GDR approach according to the present specification treats virtual boundaries between clean areas and dirty areas as “picture boundaries” for CUs in a clean area of a current picture. Hence, for intra CUs in a clean area of a current picture, the reference samples in a dirty area of the current picture are considered “not available”, and if needed for certain intra prediction modes, they will be replaced by the reference samples from the clean area of the current picture or they will be set to a pre-determined value, e.g. 2\hat{ }(BD-1), where BD is the bit depth and the notation x\hat{ }y means x to the power of y.

In the following, some details of the approach regarding different prediction modes will be described.

FIG. 4 shows an example related to an angular intra mode, where an intra CU (grey area) in the clean area 501 of a current picture and some of its reference samples (hatched rectangle) for angular intra modes (or prediction directions, illustrated with diagonal lines) are in the dirty area 502 of the current picture. With the GDR approach according to the present specification, the reference samples in the dirty area are considered as “not available”, and if needed, they will be replaced by reference samples in the clean area or set to a pre-determined value, e.g. 2\hat{ }(BD-1), where BD is the bit depth.

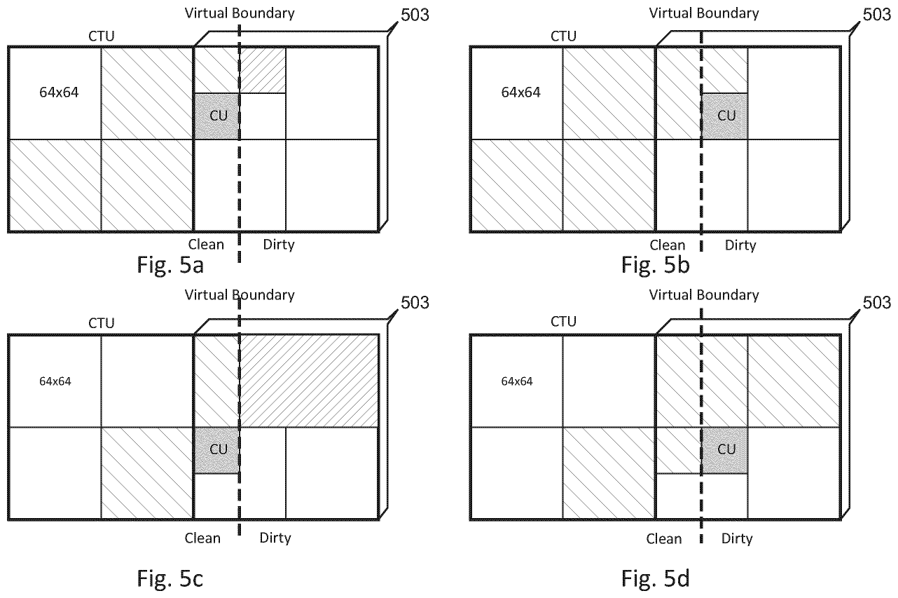

In VVC, a CU in the intra block copy (IBC) mode may refer to the past coded blocks of a current picture. These blocks are indicated with diagonally from top-left to bottom-right hatched areas in FIGS. 5a to 5d and other figures, if not indicated otherwise. FIGS. 5a to 5d show an example, where there are four figures, where CUs in intra block copy mode may refer to a past-coded area of a current picture. In each of the four figures, the dotted vertical line is the virtual boundary and a mixed-area CTU 503 of 128×128 pixels spans both the clean area and the dirty area. A current CU (in gray) may refer to the past coded area. For clean-area CUs in the mixed-area CTU 503, some pixels in the past coded area of the current picture may be in the dirty area. In the GDR approach according to the present specification, for clean-area CUs, the dirty-area pixels in the past coded area are considered as “not available”, and if needed, they will be replaced by the pixels of the clean area or set to a pre-determined value, e.g. 2\hat{ }(BD-1), where BD is the bit depth.

For example, in FIG. 5a, a current CU (in gray) in IBC mode is in the clean area of a mixed-area CTU 503 of 128×128 pixels. For the current clean-area CU (in gray), the dirty-area reconstructed pixels (indicated with diagonally from bottom-left to top-right hatched areas) in the past coded area of the current picture are considered as “not available”. If needed, the dirty-area reconstructed pixels (in diagonal lines) in the past coded area (diagonally hatched area) of current picture are padded from the reconstructed pixels in clean area or set to a pre-determined value, e.g. 2\hat{ }(BD-1), where BD is the bit depth.

Similarly, in FIG. 5b, for clean-area CUs (in gray) of IBC mode in the mixed-area CTU 503 of 128×128, the dirty-area reconstructed pixels (in diagonal lines) in the past coded area of current picture are considered as “not available”. If needed, the dirty-area reconstructed pixels (in diagonal lines) in the past coded blocks (cross-hatched area) of the current picture are padded from the reconstructed pixels in the clean area or set to a pre-determined value, e.g. 2\hat{ }(BD-1), where BD is the bit depth.

In FIG. 5c, a current CU (in gray) in IBC mode is on the dirty side of a mixed-area CTU 503 of 128×128. For the current dirty area CU (in gray), the virtual boundary (dotted vertical line) is treated as no boundary. The current CU is free to use any reconstructed pixels in the past coded area (cross-hatched area) of the current picture.

Similarly, in FIG. 5d, the dirty-area CU (in gray) in IBC mode is free to use any reconstructed pixels in the past coded area of current picture.

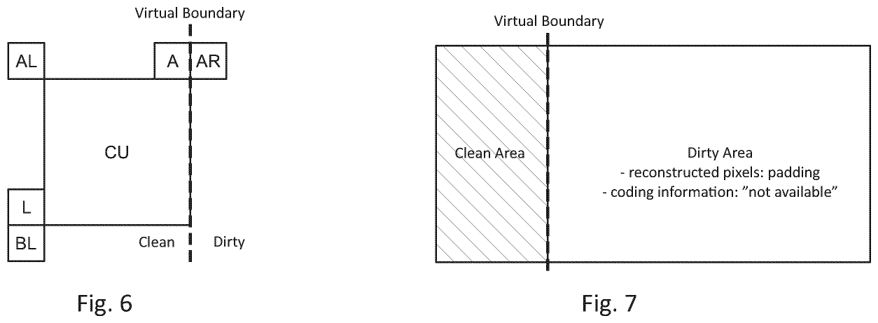

An enhanced compression model (ECM) introduces a new intra coding tool called a secondary most probable mode (MPM) for the intra prediction mode (IPM). With this new intra coding tool, the intra prediction modes of 4×4 blocks of picture are stored. If not available, the intra prediction mode for an 4×4 block is set to the intra prediction mode of its collocated 4×4 block in a reference picture. For a current CU, a most probable mode list may be built as planar, or intra prediction modes of the neighboring 4×4 blocks in the order of L (Left), A (Above), BL (Below-Left), AR (Above-Right), AL (Above-Left). However, use of this new intra coding tool may cause leaks for GDR. FIG. 6 shows an example, where the dotted vertical line illustrates the virtual boundary and a current CU is on the clean side of the virtual boundary i.e. on the left side of the virtual boundary in this example. The AR 4×4 block of the current CU is in the dirty area. If the intra prediction mode of AR is used for the current CU in clean-area, leak likely occurs.

In addition, the intra prediction mode of the neighboring 4×4 blocks of the current CU may be set to the intra prediction mode of their collocated 4×4 blocks in reference pictures. If the collocated 4×4 blocks are in dirty areas of the reference pictures, mismatch between encoder and decoder may happen because the coding information in dirty areas may not be correctly decoded at a decoder.

In accordance to an embodiment, this is solved as follows.

For CUs of the intra prediction mode in a clean area of a current picture, the intra prediction modes of 4×4 blocks in the dirty-area are considered as “not available”, and if needed, they are padded from the intra prediction modes of the (neighboring) 4×4 blocks in the clean area or set to a pre-determined intra prediction mode value, e.g. IPM=0.

Since the GDR approach according to the present specification treats virtual boundaries between clean areas and dirty areas as “picture boundaries” for CUs in a clean area of a current picture, the following procedures may be applied for inter CUs in the clean area of the current picture.

The reconstructed pixels in the dirty areas of reference pictures are considered as “not available”, and if needed, they are padded from the reconstructed pixels in the clean areas of reference pictures or set to a pre-determined value, e.g. 2\hat{ }(BD-1), where BD is the bit depth, which will give predictions of CUs in the clean area more freedom over the reference pictures, instead of being limited to the clean areas of reference pictures.

The coding information in the dirty areas of reference pictures are considered “not available” or “not inter mode”, which will prevent inter modes (e.g. TMVP) from using the coding information in the dirty areas of reference pictures.

Coding information in the dirty area of the current picture is also considered “not available”, which will prevent inter modes (e.g. merge mode, AMVP, HMVP, affine), and other possible modes (e.g. IBC merge and IBC HMVP) from using coding information in the dirty areas of the current picture.

FIG. 7 shows a reference picture for CUs in the clean area, where the reconstructed pixels in dirty area of the reference picture are padded from the reconstructed pixels in the clean area of the reference picture and the coding information in the dirty area are set as “not available”.

Since an encoder and a decoder may maintain the same set of reference pictures, including reconstructed pictures and coding information, CUs in a clean area of a current picture can refer to any portion of reference pictures without causing leaks.

History-based MVP (HMVP) is one of the new coding tools adopted by VVC. HMVP aims to allow more diversity in MVP candidate list by including recently coded motion information. Unlike traditional spatial neighbor candidates, a HMVP candidate may correspond to a past inter coded CU that is not adjacent to a current CU. The past inter coded CU, however, may be in the dirty area, which may cause leaks for GDR applications.

HMVP maintains a table of size up to 5 during the encoding/decoding process. For a current CU, the entries of HMVP table are the motion information (MI) of the past inter coded CUs, and may be used as merge candidates and/or AMVP candidates. The table is updated after coding a non-subblock inter CU, with the associated motion information (MI) being added to the HMVP table following the first-in-first-out (FIFO) rule. Before adding new motion information into the HMVP table, identical entry (or motion information), if existing, or the oldest entry in the HMVP table is removed from the HMVP table and all the HMVP entries afterwards are moved forward. The table is reset (emptied) for a new coding tree unit (CTU) row.

In the GDR approach according to the present specification, for CUs in the clean area of the current picture, the coding information in the dirty area of the current picture is considered as “not available”. Hence, the HMVP table for CUs in the clean area will only include the motion information of a previously-coded CUs in the clean area. One possible implementation is to form the HMVP table with only the motion information of previously-coded inter CUs in clean area for clean-area inter CUs and with the motion information of previously-coded inter CUs in both clean and dirty area for dirty-area inter CUs.

An alternative implementation is maintaining two separate HMVP tables, one for CUs in the clean area and the other for CUs in the dirty area. The HMVP table for CUs in the clean area may be updated with only the motion information of previously-coded inter CUs in the clean area. The motion information associated with CUs in the dirty area will therefore not be included in the merge list and the AMVP candidate list for the clean-area CUs via HMVP.

On the other hand, the HMVP table for CUs in the dirty area may be updated with the motion information of previously-coded inter CUs in both the clean area and the dirty area.

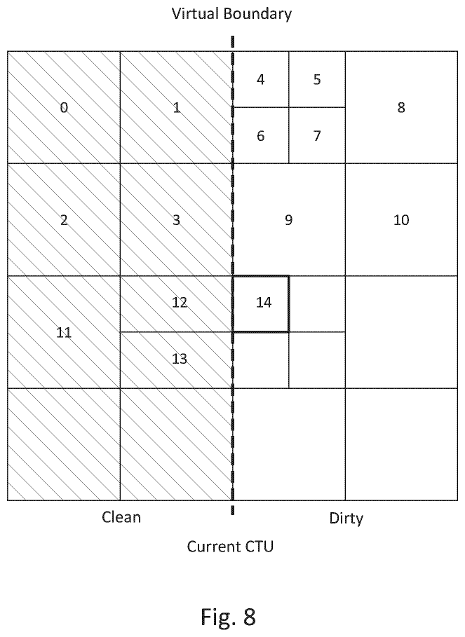

FIG. 8 shows a mixed-area CTU, where the dotted vertical line is the virtual boundary, and the clean area is on the left side and the dirty area is on the right side of the virtual boundary. When at the clean-area CU labelled with the number 13, the clean-area HMVP table contains the motion information from CUs 12, 11, 3, 2, and 1, all in the clean area, while the dirty-area HMVP table has motion information from CUs 12, 11, 10, 9, and 8, where CUs 10, 9 and 8 are in the dirty area. The clean-area HMVP table is used for CU 13. After CU 13 is coded, the clean-area HMVP table is updated with motion information from CUs 13, 12, 11, 3 and 2, and the dirty-area HMVP table is updated with motion information from CUs 13, 12, 11, 10, and 9. The dirty-area HMVP table is used for CU 14. After CU 14 is coded, the clean-area HMVP table remains unchanged, but the dirty-area HMVP is updated with motion information from CUs 14, 13, 12, 11 and 10.

In another alternative implementation, a single HMVP table may be used. That single table can be reset to an initial (e.g. empty) state at the beginning of the CTU row, or may be initialized to contain values obtained from clean areas of already processed CTU rows, which may be above, when processing CTU rows from top to bottom, or below, when processing CTU rows from bottom to top. When operating on CTUs which are fully or partially in the clean area the table is updated only with motion information associated with blocks of the clean area. This may guarantee leakless reconstruction of the list in both an encoder and a decoder for blocks inside the clean area. Once the encoding or decoding reaches the first CTU that belongs fully to the dirty area, the single HMVP table can be updated with motion information from the dirty blocks, as the requirement for leakless reconstruction is no longer valid for the rest of the CTU row. The same approach can also be used for other coding tools and mechanisms, given that the memory required for the tool is reset at the beginning of the CTU row and there are no CTUs with clean area blocks after the first CTU with only dirty area blocks in the decoding order on the same CTU row.

Similar concept of HMVP may also be applied to IBC HMVP. That is, for CUs in the clean area of the current picture, IBC HMVP table contains only the IBC of the past-coded CUs in the clean area, while for CUs in dirty area, IBC HMVP table contains IBC of the past-coded CUs in both the clean area and the dirty area.

For CUs in the dirty area of the current picture, virtual boundaries between clean area and dirty area are treated as no boundaries.

For intra CUs in the dirty area of the current picture, the reconstructed pixels in both clean area and dirty area of the current picture can be used.

For inter CUs in the dirty area of the current picture, the reconstructed pixels in both clean areas and dirty areas of reference pictures can be used. The coding information (e.g. code mode, MVs, refIdx, etc.) in both clean areas and dirty areas of reference pictures and the current picture can be used.

CUs in the dirty area are allowed to use the candidates from regular inter HMVP and regular IBC HMVP tables.

In the following, some aspects regarding filtering will be described.

In GDR implementation under the current VVC spec, in-loop filters (deblocking, SAO and ALF) have to be disabled at a virtual boundary because the in-loop filters use the pixels on both sides of the virtual boundary, causing the pixels in the dirty area to possibly contaminate the pixels in the clean area. Disabling in-loop filters, however, may have impact on picture quality (especially subjective quality) around the virtual boundary.

The GDR approach according to the present specification treats virtual boundaries between clean areas and dirty areas as “picture boundaries” for the clean area and as “no boundaries” for the dirty area. Hence, in the GDR approach according to the present specification, in-loop filtering can be performed at a virtual boundary without leaks.

Specifically, for pixels on the dirty-area side of the virtual boundary, in-loop filters may be enabled normally, as if there was no virtual boundary. In-loop filters may be allowed to use the coding information (e.g. recon pixels, code mode, refIdx, MVs, etc.) in both the clean and dirty areas.

For pixels on the clean-area side of the virtual boundary, in-loop filters may also be enabled, but in-loop filters are not allowed to use the coding information in the dirty area. The coding information in the dirty area is considered as “not available” and when needed, the coding information is padded or derived from the clean area or pre-set.

In an embodiment, an encoder adjusts the conformance cropping window picture by picture within the GDR period in a way that the number of sample columns (or rows) that are outside the conformance cropping window are selected so that the boundary between the clean and dirty area is CTU-aligned. This embodiment enables incrementing the clean area at granularity that is less than one CTU column wide or one CTU row high, while keeping the boundary between the clean and dirty areas CTU-aligned so that encoding limitations to achieve GDR are simpler. The area outside the conformance cropping window may have any content and can be coded with the most rate-efficient manner without considering its distortion.

In an embodiment, in addition to adjusting the conformance cropping window picture by picture so that the boundary between the clean and dirty area is CTU-aligned, the encoder inserts a tile column boundary (or a tile row boundary for top-to-bottom or bottom-to-top clean area evolution) between dirty and clean areas.

In an embodiment, in addition to adjusting the conformance cropping window picture by picture so that the boundary between the clean and dirty area is CTU-aligned, the encoder inserts a slice boundary between dirty and clean areas. The dirty area of a picture is enclosed in slice(s) separate from slice(s) enclosing the clean area. For example, rectangular slices (i.e., pps_rect_slice_flag equal to 1 in VVC) may be used. Consequently, two slices per picture is sufficient, one slice for the dirty area (also including the area outside the conformance cropping window) and another slice for the clean area. However, rectangular slices might not be suitable for some low-delay applications where slice size in bytes is adjusted for transmission. Raster-scan slices may be suitable for adjusting the slice size in bytes. However, if raster-scan slices are used, left-to-right or right-to-left clean area evolution would cause two slices per each CTU row, which causes bitrate increase due to a large number of slices (and the overhead caused by NAL unit headers and slice headers) and compression efficiency decreases since in-picture prediction is disabled over slice boundaries. Thus, for raster scan slices, top-to-bottom or bottom-to-top refreshing may be more suitable. When used with top-to-bottom or bottom-to-top refreshing, one or more complete raster-scan slices cover the clean area in each picture, and one or more complete raster-scan slices cover the dirty area in each picture.

In an embodiment, rather than inserting a virtual boundary between the clean and dirty areas, the encoder may control loop filtering across slice boundaries. For example, an encoder may indicate whether a slice boundary is treated like a picture boundary or like a conventional slice boundary.

Below in Table 1 is an example of a syntax for enabling in-loop filter at a virtual boundary.

```
TABLE 1
if( sps_virtual_boundaries_enabled_flag && !sps_virtual_boundaries_present_flag ) {
  ph_virtual_boundaries_present_flag
  if( ph_virtual_boundaries_present_flag ) {
    ph_num_ver_virtual_boundaries
    for( i = 0; i < ph_num_ver_virtual_boundaries; i++ )
      ph_virtual_boundary_pos_x_minus1[ i ]
    ph_num_hor_virtual_boundaries
    for( i = 0; i < ph_num_hor_virtual_boundaries; i++ )
      ph_virtual_boundary_pos_y_minus1[ i ]
    ph_loop_filter_across_virtual_boundaries_enabled_flag
```

| | |
|---|---|
| for( | vidx = 0; ph_loop_filter_across_virtual_boundaries_enabled_flag && |
| | vidx < ph_num_ver_virtual_boundaries * 2; vidx++ ) |

ph_ver_virtual_boundary_mode_flag[ vidx ]

| | |
|---|---|
| for( | hidx = 0; ph_loop_filter_across_virtual_boundaries_enabled_flag && |
| | hidx < ph_num_hor_virtual_boundaries * 2; hidx++ ) |

```
      ph_hor_virtual_boundary_mode_flag[ hidx ]
  }
}
```

The following explains the syntax in more detail. It should be noted, however, that the described meaning of the values 0 and 1 may also be reversed or different values may be used instead.

ph_loop_filter_across_virtual_boundaries_enabled_flag equal to 0 specifies that in-loop filtering operations across virtual boundaries are disabled. ph_loop_filter_across_virtual_boundaries_enabled_flag equal to 1 specifies that in-loop filtering operations across virtual boundaries are enabled.

A variable verBnd is set equal to vidx/2.

ph_ver_virtual_boundary_mode_flag[vidx] equal to 0, when vidx % 2 is equal to 0, specifies that in-loop filtering operations that apply across the verBnd-th vertical virtual boundary and modify sample values on the left of the verBnd-th vertical virtual boundary use sample values on the right of the verBnd-th vertical virtual boundary. The %-sign means a modulo operation i.e. vidx MOD 2, which gives the remainder of the division by 2.

ph_ver_virtual_boundary_mode_flag[vidx] equal to 0, when vidx % 2 is equal to 1, specifies that in-loop filtering operations that apply across the verBnd-th vertical virtual boundary and modify sample values on the right of the verBnd-th vertical virtual boundary use sample values on the left of the verBnd-th vertical virtual boundary.

ph_ver_virtual_boundary_mode_flag[vidx] equal to 1, when vidx % 2 is equal to 0, specifies that in-loop filtering operations that apply across the verBnd-th vertical virtual boundary and modify sample values on the left of the verBnd-th vertical virtual boundary use padded sample values of the left boundary pixel of the verBnd-th vertical virtual boundary (or pre-set values).

ph_ver_virtual_boundary_mode_flag[vidx] equal to 1, when vidx % 2 is equal to 1, specifies that in-loop filtering operations that apply across the verBnd-th vertical virtual boundary and modify sample values on the right of the verBnd-th vertical virtual boundary use padded sample values of the right boundary pixel of the verBnd-th vertical virtual boundary (or pre-set values).

The semantics for horizontal boundaries, i.e. ph_hor_virtual_boundary_mode_flag[i], are specified similarly, i.e. as follows.

A variable horBnd is set equal to vidx/2.

ph_hor_virtual_boundary_mode_flag[vidx] equal to 0, when vidx % 2 is equal to 0, specifies that in-loop filtering operations that apply across the horBnd-th horizontal virtual boundary and modify sample values on the left of the horBnd-th horizontal virtual boundary use sample values on the right of the horBnd-th horizontal virtual boundary. The %-sign means a modulo operation i.e. vidx MOD 2, which gives the remainder of the division by 2.

ph_hor_virtual_boundary_mode_flag[vidx] equal to 0, when vidx % 2 is equal to 1, specifies that in-loop filtering operations that apply across the horBnd-th horizontal virtual boundary and modify sample values on the right of the horBnd-th horizontal virtual boundary use sample values on the left of the horBnd-th horizontal virtual boundary.

ph_hor_virtual_boundary_mode_flag[vidx] equal to 1, when vidx % 2 is equal to 0, specifies that in-loop filtering operations that apply across the horBnd-th horizontal virtual boundary and modify sample values on the left of the horBnd-th horizontal virtual boundary use padded sample values of the left boundary pixel of the horBnd-th horizontal virtual boundary (or pre-set values).

ph_hor_virtual_boundary_mode_flag[vidx] equal to 1, when vidx % 2 is equal to 1, specifies that in-loop filtering operations that apply across the horBnd-th horizontal virtual boundary and modify sample values on the right of the horBnd-th horizontal virtual boundary use padded sample values of the right boundary pixel of the horBnd-th horizontal virtual boundary (or pre-set values).

It needs to be understood that the above-described syntax and semantics present one example embodiment and other embodiments may be realized similarly. For example, various embodiments could cover the following:

In an embodiment, per each virtual boundary and “direction” (left to right or right to left for vertical virtual boundaries or top to bottom or bottom to top for horizontal virtual boundaries), the following properties may be indicated:
in-loop filtering is turned off across the virtual boundary;
in-loop filters are enabled normally across the virtual boundary, as if there was no virtual boundary;
in-loop filters across the virtual boundary are enabled, but the coding information in dirty area are considered as “not available” and when needed, they are padded or derived from the clean area or pre-set.

In an embodiment, one or more syntax elements indicative of the clean area in relation to one or more virtual boundaries is included by an encoder in or along the bitstream, e.g. in a picture parameter set or a picture header, or decoded by a decoder from or along the bitstream. The syntax element may, for example, be a flag, where value 0 indicates a clean area of on the left of or above a vertical or horizontal virtual boundary, respectively, and value 1 indicates a clean area of on the right of or below a vertical or horizontal virtual boundary, respectively, or vice-versa. The flag may be present in a GDR picture and may be inferred or indicated to be present in a recovering picture.

In some embodiments, gradual decoding refresh might not be horizontal or vertical, but it may have another pattern, such as diagonal. For example, a clean area may gradually grow from the top-left, top-right, bottom-left, or bottom-right corner towards to opposite corner of a picture. The above-described embodiments may similarly apply to more than one virtual boundary, e.g. to a horizontal virtual boundary and a vertical virtual boundary being present in the same picture.

In an embodiment, both a vertical virtual boundary and a horizontal virtual boundary are present in the same picture, and a flag indicative of the clean area in relation to one or more virtual boundaries is included by an encoder in or along the bitstream, e.g. in a picture parameter set or a picture header, or decoded by a decoder from or along the bitstream and a flag, where value 0 of the flag indicates a clean area of on the left of and above a vertical or horizontal virtual boundary, respectively, and value 1 indicates a clean area of on the right of and below a vertical or horizontal virtual boundary, respectively, or vice-versa. The flag may be present in a GDR picture and may be inferred or indicated to be present in a recovering picture.

In an embodiment, both a vertical virtual boundary and a horizontal virtual boundary are present in the same picture, and two flags indicative of the clean area in relation to one or more virtual boundaries are included by an encoder in or along the bitstream, e.g. in a picture parameter set or a picture header, or decoded by a decoder from or along the bitstream. A first flag equal to 0 indicates a clean area of on the left of a vertical virtual boundary, and equal to 1 indicates a clean area of on the right of a vertical virtual boundary, or vice-versa. A second flag equal to 0 indicates a clean area of above of a horizontal virtual boundary, and equal to 1 indicates a clean area of below of a horizontal virtual boundary, or vice-versa. The flags may be present in a GDR picture and may be inferred or indicated to be present in a recovering picture.

In the following, some aspects regarding deblocking will be described.

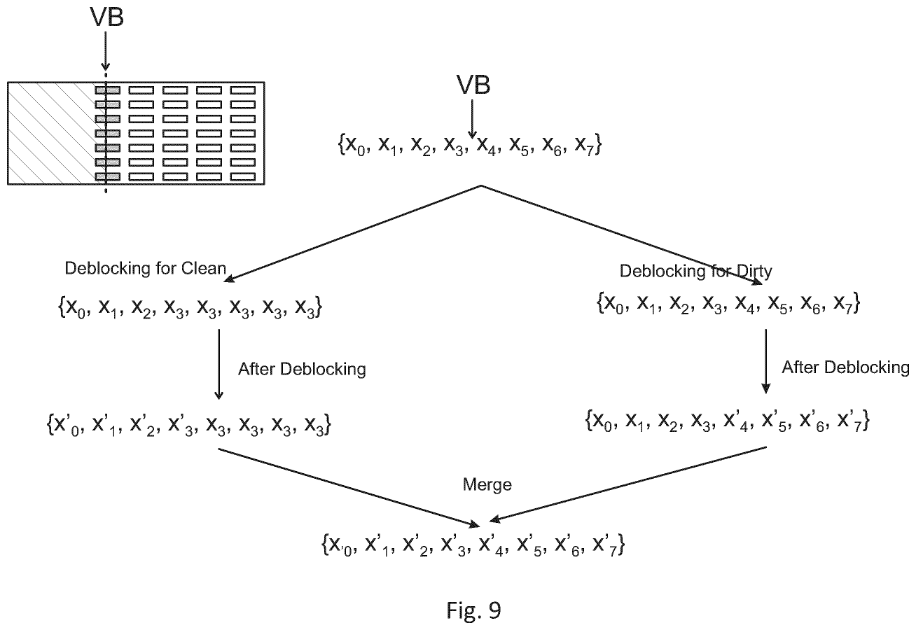

FIG. 9 shows an example of a deblocking filter at the virtual boundary, where pixels x0, x1, x2, and x3 are in the clean area and x4, x5, x6 and x7 in the dirty area.

When deblocking of the dirty-area pixels of x4, x5, x6 and x7, the clean-area pixels of x0, x1, x2 and x3 can be used in filtering calculation.

However, when deblocking of the clean-area pixels of x0, x1, x2 and x3, the dirty-area pixels of x4, x5, x6 and x7 should not be used in filtering calculation. Instead, the dirty-area pixels of x4, x5, x6 and x7 are replaced by the clean-area pixel of x3 or set to a pre-determined value, e.g. 2\hat{ }(BD-1), where BD is the bit depth.

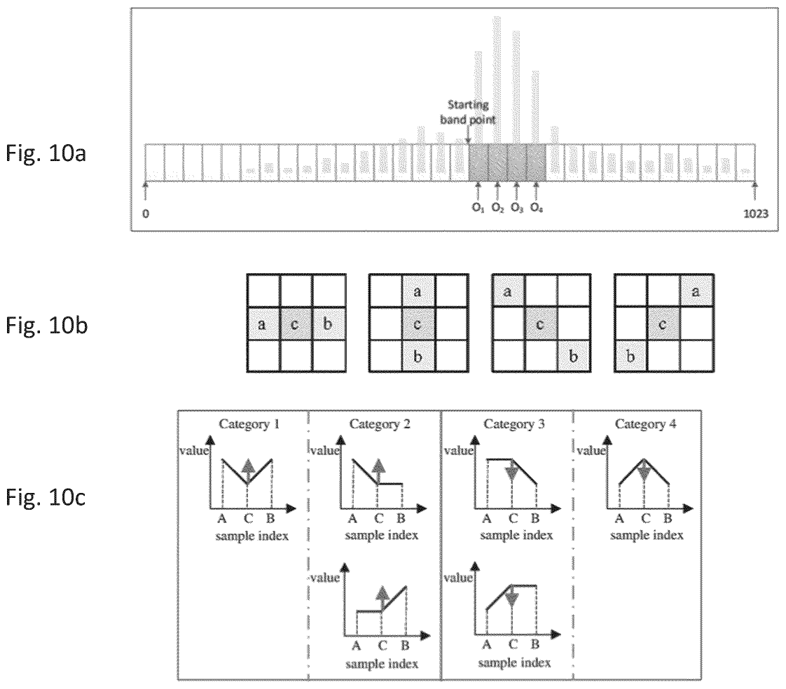

In VVC, the sample adaptive offset filtering has two parts. They are band offset and edge offset. An encoder can choose to use either the band offset or the edge offset for each CTU. The choice of band offset or edge offset per CTU is signaled. For a CTU, if the band offset is used, a set of parameters e.g. a starting position of four consecutive bends, an absolute offset value and sign for each band, as is illustrated in FIG. 10a, are signaled. The set of parameters are applied to the pixels of the CTU independently without referring to other pixels. Hence, the band offset may not cause any leak for GDR.

For a CTU, if the edge offset is used, a set of parameters such as an edge class, as shown in FIG. 10b, and offsets for four edge categories, as shown in FIG. 10c, are signaled.

As can be seen from FIG. 10c, categorizing the edge of a pixel may require to use the neighboring pixels. Therefore, the pixels in the clean area pixels may be contaminated by the neighboring pixels in the dirty area via the edge offset operation. In the GDR approach according to the present specification, for a clean-area pixel in a CTU with the edge offset, the dirty-area neighboring pixels are considered as “not available”, and if needed, they are padded from the clean-area pixels or set to a pre-determined value, e.g. 2\hat{ }(BD-1), where BD is the bit depth; and for a dirty-area pixel in a CTU with the edge offset, both the clean-area and the dirty-area neighboring pixels can be used.

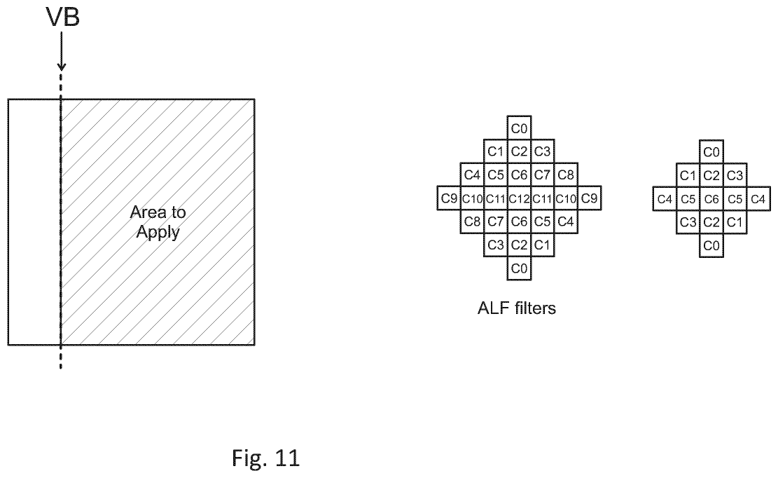

FIG. 11 shows an example of an adaptive loop filter at a virtual boundary. On the left side of FIG. 11, a block to be filtered is illustrated. The dotted vertical line illustrates the virtual boundary, the area on the left of the virtual boundary is the clean area, and the area on the right of the virtual boundary is the dirty area. On the right side of FIG. 11, examples of adaptive loop filters are shown.

When the adaptive loop filtering of the dirty-area pixels is used, the virtual boundary should be treated as no boundary. Both the pixels in the clean-area and in the dirty area can be used in filtering calculation.

On the other hand, when the adaptive loop filtering of the clean-area pixels is used, the dirty-area pixels are considered as “not available”, and if needed in filtering calculation, they are padded or mirrored from the clean area or set to a pre-determined value, e.g. 2\hat{ }(BD-1), where BD is the bit depth.

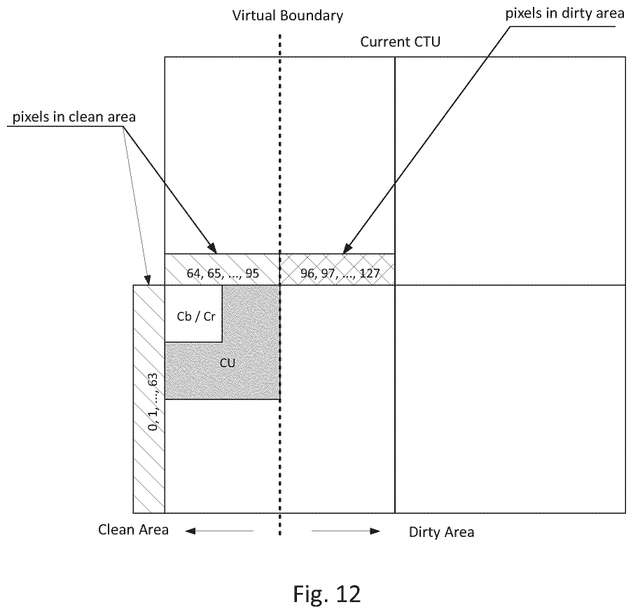

In GDR implementation under the current VVC spec, chroma residual scaling of luma mapping with chroma scaling has to be disabled, otherwise leaks will likely occur. The GDR approach according to the present specification treats virtual boundaries between clean areas and dirty areas as “picture boundaries” for clean area of a current picture and as “no boundaries” for dirty area of the current picture. Hence, in the GDR approach according to the present specification, chroma residual scaling of LMCS may be performed without leaks, which may help to improve the quality of chroma components. Specifically, for CUs in the clean area, the reconstructed luma neighboring pixels (e.g. pixels 96 to 127 in FIG. 12) in the dirty area are considered as “not available”, and if needed for LMCS, they are padded from the clean area or set to a pre-determined value, e.g. 2\hat{ }(BD-1), where BD is the bit depth.

For CUs in the dirty area, the reconstructed luma neighboring pixels in both the clean area and the dirty area are allowed to be used in calculating the chroma scaling factor of LCMS.

To further improve the coding performance of GDR, the forced intra area or strip of recovering pictures may be removed. The GDR approach according to the present specification may let an encoder select intra/inter mode per CU in the clean area.

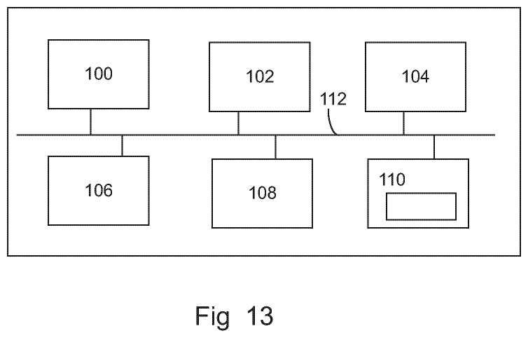

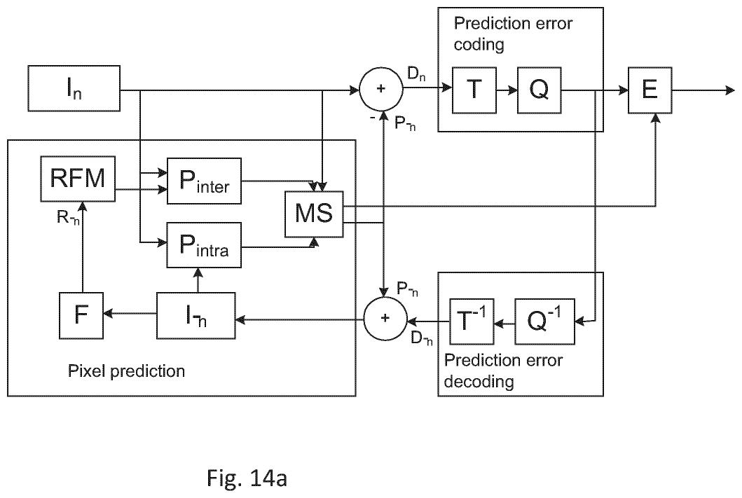

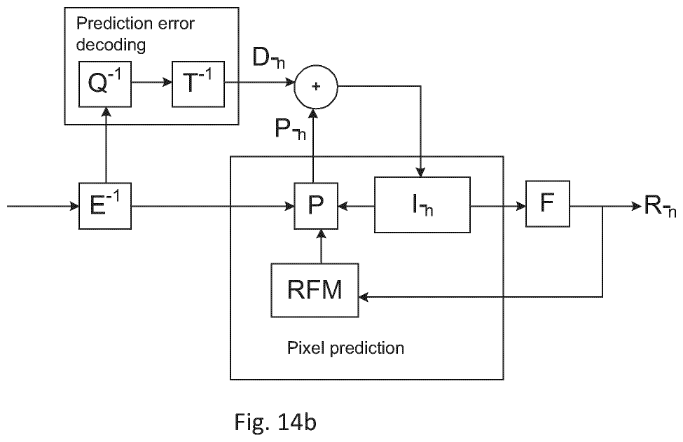

An example of a data processing system for an apparatus is illustrated in FIG. 13. Several functionalities can be carried out with a single physical device, e.g. all calculation procedures can be performed in a single processor if desired. The data processing system comprises a main processing unit 100, a memory 102, a storage device 104, an input device 106, an output device 108, and a graphics subsystem 110, which are all connected to each other via a data bus 112.

The main processing unit 100 is a conventional processing unit arranged to process data within the data processing system. The main processing unit 100 may comprise or be implemented as one or more processors or processor circuitry. The memory 102, the storage device 104, the input device 106, and the output device 108 may include conventional components as recognized by those skilled in the art. The memory 102 and storage device 104 store data in the data processing system 100.

Computer program code resides in the memory 102 for implementing, for example a method as illustrated in a flowchart of FIG. 15 according to various embodiments. The input device 106 inputs data into the system while the output device 108 receives data from the data processing system and forwards the data, for example to a display. The data bus 112 is a conventional data bus and while shown as a single line it may be any combination of the following: a processor bus, a PCI bus, a graphical bus, an ISA bus. Accordingly, a skilled person readily recognizes that the apparatus may be any data processing device, such as a computer device, a personal computer, a server computer, a mobile phone, a smart phone or an Internet access device, for example Internet tablet computer.

FIG. 11 illustrates an example of a video encoder, where In: Image to be encoded; P'n: Predicted representation of an image block; Dn: Prediction error signal; D'n: Reconstructed prediction error signal; I'n: Preliminary reconstructed image; R'n: Final reconstructed image; T, T-1: Transform and inverse transform; Q, Q-1: Quantization and inverse quantization; E: Entropy encoding; RFM: Reference frame memory; Pinter: Inter prediction; Pintra: Intra prediction; MS: Mode selection; F: Filtering. FIG. 12 illustrates a block diagram of a video decoder where P'n: Predicted representation of an image block; D'n: Reconstructed prediction error signal; I'n: Preliminary reconstructed image; R'n: Final reconstructed image; T-1: Inverse transform; Q-1: Inverse quantization; E-1: Entropy decoding; RFM: Reference frame memory; P: Prediction (either inter or intra); F: Filtering. An apparatus according to an embodiment may comprise only an encoder or a decoder, or both.

The various embodiments can be implemented with the help of computer program code that resides in a memory and causes the relevant apparatuses to carry out the method. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of various embodiment.

If desired, the different functions discussed herein may be performed in a different order and/or concurrently with other. Furthermore, if desired, one or more of the above-described functions and embodiments may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications, which may be made without departing from the scope of the present disclosure as, defined in the appended claims.

In some embodiments, an apparatus can be configured to carry out some or all portions of any of the methods described herein. The apparatus may be embodied by any of a wide variety of devices including, for example, a video codec. A video codec includes an encoder that transforms input video into a compressed representation suited for storage and/or transmission and/or a decoder that can decompress the compressed video representation to result in a viewable form of a video. Typically, the encoder discards some information from the original video sequence to represent the video in a more compact form, such as at a lower bit rate. As an alternative to a video codec, the apparatus may, instead, be embodied by any of a wide variety of computing devices including, for example, a video encoder, a video decoder, a computer workstation, a server or the like, or by any of various mobile computing devices, such as a mobile terminal, e.g., a smartphone, a tablet computer, a video game player, etc. Alternatively, the apparatus may be embodied by an image capture system configured to capture the images that comprise the volumetric video data.

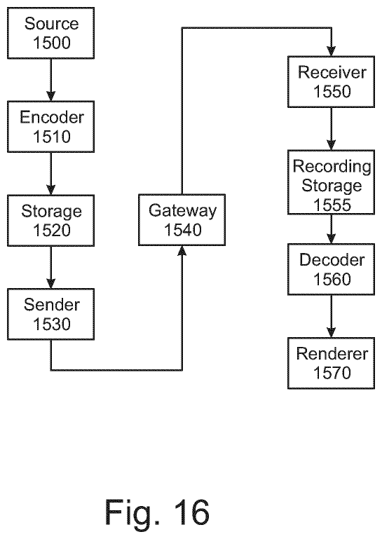

FIG. 16 shows a schematic diagram of an example multimedia communication system within which various embodiments may be implemented. A data source 1500 provides a source signal in an analog, uncompressed digital, or compressed digital format, or any combination of these formats. An encoder 1510 may include or be connected with a pre-processing, such as data format conversion and/or filtering of the source signal. The encoder 1510 encodes the source signal into a coded media bitstream. It should be noted that a bitstream to be decoded may be received directly or indirectly from a remote device located within virtually any type of network. Additionally, the bitstream may be received from local hardware or software. The encoder 1510 may be capable of encoding more than one media type, such as audio and video, or more than one encoder 1510 may be required to code different media types of the source signal. The encoder 1510 may also get synthetically produced input, such as graphics and text, or it may be capable of producing coded bitstreams of synthetic media. In the following, only processing of one coded media bitstream of one media type is considered to simplify the description. It should be noted, however, that typically real-time broadcast services comprise several streams (typically at least one audio, video and text sub-titling stream). It should also be noted that the system may include many encoders, but in the figure only one encoder 1510 is represented to simplify the description without a lack of generality. It should be further understood that, although text and examples contained herein may specifically describe an encoding process, one skilled in the art would understand that the same concepts and principles also apply to the corresponding decoding process and vice versa.

The coded media bitstream may be transferred to a storage 1520. The storage 1520 may comprise any type of mass memory to store the coded media bitstream. The format of the coded media bitstream in the storage 1520 may be an elementary self-contained bitstream format, or one or more coded media bitstreams may be encapsulated into a container file, or the coded media bitstream may be encapsulated into a Segment format suitable for DASH (or a similar streaming system) and stored as a sequence of Segments. If one or more media bitstreams are encapsulated in a container file, a file generator (not shown in the figure) may be used to store the one more media bitstreams in the file and create file format metadata, which may also be stored in the file. The encoder 1510 or the storage 1520 may comprise the file generator, or the file generator is operationally attached to either the encoder 1510 or the storage 1520. Some systems operate “live”, i.e. omit storage and transfer coded media bitstream from the encoder 1510 directly to the sender 1530. The coded media bitstream may then be transferred to the sender 1530, also referred to as the server, on a need basis. The format used in the transmission may be an elementary self-contained bitstream format, a packet stream format, a Segment format suitable for DASH (or a similar streaming system), or one or more coded media bitstreams may be encapsulated into a container file. The encoder 1510, the storage 1520, and the server 1530 may reside in the same physical device or they may be included in separate devices. The encoder 1510 and server 1530 may operate with live real-time content, in which case the coded media bitstream is typically not stored permanently, but rather buffered for small periods of time in the content encoder 1510 and/or in the server 1530 to smooth out variations in processing delay, transfer delay, and coded media bitrate.

The server 1530 sends the coded media bitstream using a communication protocol stack. The stack may include but is not limited to one or more of Real-Time Transport Protocol (RTP), User Datagram Protocol (UDP), Hypertext Transfer Protocol (HTTP), Transmission Control Protocol (TCP), and Internet Protocol (IP). When the communication protocol stack is packet-oriented, the server 1530 encapsulates the coded media bitstream into packets. For example, when RTP is used, the server 1530 encapsulates the coded media bitstream into RTP packets according to an RTP payload format. Typically, each media type has a dedicated RTP payload format. It should be again noted that a system may contain more than one server 1530, but for the sake of simplicity, the following description only considers one server 1530.

If the media content is encapsulated in a container file for the storage 1520 or for inputting the data to the sender 1530, the sender 1530 may comprise or be operationally attached to a “sending file parser” (not shown in the figure). In particular, if the container file is not transmitted as such but at least one of the contained coded media bitstream is encapsulated for transport over a communication protocol, a sending file parser locates appropriate parts of the coded media bitstream to be conveyed over the communication protocol. The sending file parser may also help in creating the correct format for the communication protocol, such as packet headers and payloads. The multimedia container file may contain encapsulation instructions, such as hint tracks in the ISOBMFF, for encapsulation of the at least one of the contained media bitstream on the communication protocol.

The server 1530 may or may not be connected to a gateway 1540 through a communication network, which may e.g. be a combination of a CDN, the Internet and/or one or more access networks. The gateway may also or alternatively be referred to as a middle-box. For DASH, the gateway may be an edge server (of a CDN) or a web proxy. It is noted that the system may generally comprise any number gateways or alike, but for the sake of simplicity, the following description only considers one gateway 1540. The gateway 1540 may perform different types of functions, such as translation of a packet stream according to one communication protocol stack to another communication protocol stack, merging and forking of data streams, and manipulation of data stream according to the downlink and/or receiver capabilities, such as controlling the bit rate of the forwarded stream according to prevailing downlink network conditions. The gateway 1540 may be a server entity in various embodiments.

The system includes one or more receivers 1550, typically capable of receiving, de-modulating, and de-capsulating the transmitted signal into a coded media bitstream. The coded media bitstream may be transferred to a recording storage 1555. The recording storage 1555 may comprise any type of mass memory to store the coded media bitstream. The recording storage 1555 may alternatively or additively comprise computation memory, such as random access memory. The format of the coded media bitstream in the recording storage 1555 may be an elementary self-contained bitstream format, or one or more coded media bitstreams may be encapsulated into a container file. If there are multiple coded media bitstreams, such as an audio stream and a video stream, associated with each other, a container file is typically used and the receiver 1550 comprises or is attached to a container file generator producing a container file from input streams. Some systems operate “live,” i.e. omit the recording storage 1555 and transfer coded media bitstream from the receiver 1550 directly to the decoder 1560. In some systems, only the most recent part of the recorded stream, e.g., the most recent 10-minute excerption of the recorded stream, is maintained in the recording storage 1555, while any earlier recorded data is discarded from the recording storage 1555.

The coded media bitstream may be transferred from the recording storage 1555 to the decoder 1560. If there are many coded media bitstreams, such as an audio stream and a video stream, associated with each other and encapsulated into a container file or a single media bitstream is encapsulated in a container file e.g. for easier access, a file parser (not shown in the figure) is used to decapsulate each coded media bitstream from the container file. The recording storage 1555 or a decoder 1560 may comprise the file parser, or the file parser is attached to either recording storage 1555 or the decoder 1560. It should also be noted that the system may include many decoders, but here only one decoder 1560 is discussed to simplify the description without a lack of generality

The coded media bitstream may be processed further by a decoder 1560, whose output is one or more uncompressed media streams. Finally, a renderer 1570 may reproduce the uncompressed media streams with a loudspeaker or a display, for example. The receiver 1550, recording storage 1555, decoder 1560, and renderer 1570 may reside in the same physical device or they may be included in separate devices.

A sender 1530 and/or a gateway 1540 may be configured to perform switching between different representations e.g. for switching between different viewports of 360-degree video content, view switching, bitrate adaptation and/or fast start-up, and/or a sender 1530 and/or a gateway 1540 may be configured to select the transmitted representation(s). Switching between different representations may take place for multiple reasons, such as to respond to requests of the receiver 1550 or prevailing conditions, such as throughput, of the network over which the bitstream is conveyed. In other words, the receiver 1550 may initiate switching between representations. A request from the receiver can be, e.g., a request for a Segment or a Subsegment from a different representation than earlier, a request for a change of transmitted scalability layers and/or sub-layers, or a change of a rendering device having different capabilities compared to the previous one. A request for a Segment may be an HTTP GET request. A request for a Subsegment may be an HTTP GET request with a byte range. Additionally or alternatively, bitrate adjustment or bitrate adaptation may be used for example for providing so-called fast start-up in streaming services, where the bitrate of the transmitted stream is lower than the channel bitrate after starting or random-accessing the streaming in order to start playback immediately and to achieve a buffer occupancy level that tolerates occasional packet delays and/or retransmissions. Bitrate adaptation may include multiple representation or layer up-switching and representation or layer down-switching operations taking place in various orders.

A decoder 1560 may be configured to perform switching between different representations e.g. for switching between different viewports of 360-degree video content, viewpoint switching, bitrate adaptation and/or fast start-up, and/or a decoder 1560 may be configured to select the transmitted representation(s). Switching between different representations may take place for multiple reasons, such as to achieve faster decoding operation or to adapt the transmitted bitstream, e.g. in terms of bitrate, to prevailing conditions, such as throughput, of the network over which the bitstream is conveyed. Thus, the decoder may comprise means for requesting at least one decoder reset picture of the second representation for carrying out bitrate adaptation between the first representation and a third representation. Faster decoding operation might be needed for example if the device including the decoder 1560 is multi-tasking and uses computing resources for other purposes than decoding the video bitstream. In another example, faster decoding operation might be needed when content is played back at a faster pace than the normal playback speed, e.g. twice or three times faster than conventional real-time playback rate.

Some embodiments have been described in relation to VVC and/or terms and syntax elements of VVC. It needs to be understood that embodiments apply similarly to any video coding format. For example, when embodiments apply to a superblock term similarly to a coding tree unit term.

In the above, some embodiments have been described with reference to encoding. It needs to be understood that said encoding may comprise one or more of the following: encoding source image data into a bitstream, encapsulating the encoded bitstream in a container file and/or in packet(s) or stream(s) of a communication protocol, and announcing or describing the bitstream in a content description, such as the Media Presentation Description (MPD) of ISO/IEC 23009-1 (known as MPEG-DASH) or the IETF Session Description Protocol (SDP). Similarly, some embodiments have been described with reference to decoding. It needs to be understood that said decoding may comprise one or more of the following: decoding image data from a bitstream, decapsulating the bitstream from a container file and/or from packet(s) or stream(s) of a communication protocol, and parsing a content description of the bitstream,

In the above, where the example embodiments have been described with reference to an encoder or an encoding method, it needs to be understood that the resulting bitstream and the decoder or the decoding method may have corresponding elements in them. Likewise, where the example embodiments have been described with reference to a decoder, it needs to be understood that the encoder may have structure and/or computer program for generating the bitstream to be decoded by the decoder.

In general, the various embodiments of the invention may be implemented in hardware or special purpose circuits or any combination thereof. While various aspects of the invention may be illustrated and described as block diagrams or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended examples. However, all such and similar modifications of the teachings of this invention will still fall within the scope of this invention.

1-17. (canceled)

18. An apparatus comprising: at least one processor; and at least one memory including computer program code; wherein the at least one memory and the computer program code are configured to, with the at least one processor, cause the apparatus at least to: obtain a coding unit of a coding tree unit of a picture comprising a refreshed region and a non-refreshed region, and a virtual boundary between the refreshed region and the non-refreshed region; examine whether the coding unit belongs to the refreshed region or to the non-refreshed region; and treat the virtual boundary as a picture boundary when it is determined that the coding unit belongs to the refreshed region, or treat the virtual boundary as no boundary when it is determined that the coding unit belongs to the non-refreshed region.

19. The apparatus according to claim 18, wherein the apparatus is further caused to: perform intra prediction for the coding unit of the picture, wherein when the coding unit belongs to the refreshed region of the picture, pixels of the non-refreshed region of the picture are considered as not available for the prediction.

20. The apparatus according to claim 19, wherein the apparatus is further caused to: obtain values for the pixels of the non-refreshed region of the picture for the prediction by performing at least one of the following: padding from one or more reconstructed pixels in the refreshed region; setting the values for the pixels of the non-refreshed region to a pre-determined value.

21. The apparatus according to claim 19, wherein the apparatus is further caused to: consider coding information in non-refreshed regions of the picture as not available.

22. The apparatus according to claim 19, wherein the apparatus is further caused to: consider coding information in the non-refreshed region of the picture as not available, wherein the coding unit in the refreshed region appears in the same tile as coding units of the non-refreshed region.

23. The apparatus according to claim 18, wherein the apparatus is further caused to: perform inter prediction for the coding unit of the picture, wherein when the coding unit belongs to the refreshed region of the picture, pixels of non-refreshed regions of reference pictures are considered as not available for the prediction.

24. The apparatus according to claim 23, wherein the apparatus is further caused to: obtain values for the pixels of the non-refreshed regions of the reference pictures for the prediction by at least one of the following: padding from one or more reconstructed pixels in refreshed regions of the reference pictures; setting to a pre-determined value.

25. The apparatus according to claim 23, wherein the apparatus is further caused to: consider coding information in the non-refreshed region of the reference pictures as not available or not inter mode.

26. The apparatus according to claim 23, wherein the apparatus is further caused to: consider coding information in the non-refreshed regions of the picture as not available.

27. The apparatus according to claim 23, wherein the apparatus is further caused to: perform motion vector prediction for the coding unit of the picture comprising maintaining at least one table including motion information of one or more past inter coded coding units, wherein the motion vector prediction comprises a history-based motion vector prediction or an intra block copy history-based motion vector prediction; and insert into the at least one table motion information of previously inter coded coding units of the refreshed region of the picture.

28. The apparatus according to claim 27, wherein the apparatus is further caused to: insert into the at least one table motion information of previously inter coded coding units of the refreshed region of the picture, for coding units in the refreshed region of the picture; and insert motion information of previously inter coded coding units of the refreshed region and previously inter coded coding units of the non-refreshed region into the at least one table, for coding units in the non-refreshed region of the picture.

29. The apparatus according to claim 18, wherein the apparatus is further caused to: perform in-loop filtering across the virtual boundary, wherein for pixels on the non-refreshed region ignoring the virtual boundary, and for pixels on the refreshed region considering coding information of the non-refreshed region as not available.

30. The apparatus according to claim 29, wherein the apparatus is further caused to: use by in-loop filtering pixel values padded or derived from the refreshed region or pre-set pixel values instead of coding information of the non-refreshed region for the pixels on the refreshed region.

31. The apparatus according to claim 18, wherein the apparatus is further caused to: start decoding from a gradual decoding reference picture; and gradually recover pictures after the gradual decoding reference picture; and output the gradual decoding reference picture and recovering pictures.

32. The apparatus according to claim 18, wherein the apparatus is further caused to:
enable all types of partitions within the coding tree unit; and construct the partitioning of the coding tree unit to coding units so that no coding unit spans both the refreshed region and the non-refreshed region.

33. A method comprising: obtaining a coding unit of a coding tree unit of a picture comprising a refreshed region and a non-refreshed region, and a virtual boundary between the refreshed region and the non-refreshed region; examining whether the coding unit belongs to the refreshed region or to the non-refreshed region; and treating the virtual boundary as a picture boundary when it is determined that the coding unit belongs to the refreshed region, or treating the virtual boundary as no boundary when it is determined that the coding unit belongs to the non-refreshed region.

34. The method according to claim 33 further comprising: performing intra prediction for the coding unit of the picture, wherein when the coding unit belongs to the refreshed region of the picture, pixels of the non-refreshed region of the picture are considered as not available for prediction.

35. The method according to claim 34 further comprising: obtaining values for the pixels of the non-refreshed region of the picture for the prediction by at least one of the following: padding from one or more reconstructed pixels in the refreshed region; setting to a pre-determined value.

36. The method according to claim 34 further comprising: considering coding information in non-refreshed regions of the picture as “not available”.

37. The method according to claim 34 further comprising: considering coding information in the non-refreshed region of the picture as “not available”, wherein the coding unit in the refreshed region appears in the same tile as coding units of the non-refreshed region.
